(19) United States
(12) Patent Application Publication
(10) Pub. No.: US 2023/0360845 A1
(43) Pub. Date: Nov. 9, 2023

(54) WINDING ARRANGEMENT FOR ELECTRICAL TRANSFORMER

(71) Applicant: Murata Manufacturing Co., Ltd., Nagaokakyo-shi (JP)

(72) Inventor: Kapila WARNAKULASURIYA, Milton Keynes (GB)

(21) Appl. No.: 18/140,270

(22) Filed: Apr. 27, 2023

(30) Foreign Application Priority Data
May 5, 2022 (GB) 2206600.5

(51) Int. Cl. H01F 27/30; H01F 27/08; H01F 27/24; H01F 30/16; H01F 27/28

(52) U.S. Cl. CPC H01F 27/306; H01F 27/08; H01F 27/24; H01F 30/16; H01F 27/2847

(57) ABSTRACT

A transformer includes primary and secondary coils that each include first and second sections that each include first and second sets of turns. In the parallel-connected first and second sections of the primary coil, the second set of turns of the second section is positioned within the first set of turns of the first section, and the second set of turns of the first section is positioned within the first set of turns of the second section. In the parallel-connected first and second sections of the secondary coil, the second set of turns of the second section is positioned within the first set of turns of the first section, and the second set of turns of the first section is positioned within the first set of turns of the second section, when viewed along a common winding axis. The turns of the primary and secondary coils are interleaved.

### CROSS REFERENCE TO RELATED APPLICATIONS

This application claims the benefit of priority to United Kingdom Patent Application No. 2206600.5 filed on May 5, 2022. The entire contents of this application are hereby incorporated herein by reference.

### BACKGROUND OF THE INVENTION

### 1. Field of the Invention

This application relates to a winding arrangement of an electrical transformer, and an electrical transformer including the winding arrangement.

### 2. Description of the Related Art

Murata's pdqb winding technology makes it possible to achieve the theoretically minimum level of high frequency conductor losses in high-power, high-frequency transformers (which typically have operating parameters above 10 kW and 10 kHz). Murata's pdqb technology is described in UK patent application publication GB2574481A and international patent application publication WO 2019/234453 A1, which are hereby incorporated by reference in their entirety.

Further, Murata's thermal management technology makes it possible to extract heat generated in compact transformer structures effectively. Murata's thermal management technology is described in UK patent application publications GB2597670A and GB2597470A, and international patent application publications WO 2022/023744 A1 and WO 2022/018436 A1, which are hereby incorporated by reference in their entirety.

FIG. 1 shows an example of an existing Murata pdqb transformer 100. The transformer 100 includes a transformer core and a set of windings contained within a closed housing. In other words, the transformer 100 has a closed construction. Known transformers, such as the transformer 100 of FIG. 1, use either completely potted constructions or completely unpotted open constructions. Both of these options have associated disadvantages.

Moreover, there are a number of parameters, approximately 40, that affect the design of a high-power, high-frequency transformer. These include the primary voltage, secondary voltage, rated power (continuous), operating frequency, primary inductance, secondary inductance, leakage inductance, primary DC resistance, secondary DC resistance, primary AC resistance, secondary AC resistance, and the interwinding capacitance. Different parameters have a different degree of significance for different applications of the transformer, making it difficult provide a single construction or even a small group of different constructions that will be suitable for all these applications.

Previous attempts to provide a universal transformer have included using different core sizes and/or core assemblies to make the transformer suitable for different voltage and frequency levels.

A power level in the range of 30 kW to 70 kW is desirable for many applications. For example, a 50-kW power level is a reasonable power level that would cover over 90% of common applications.

It is desirable to provide an improved, cost-effective single transformer construction applicable to many applications. In particular, a construction where only minor adjustments can make the transformer universal for the above-mentioned power level over a range of voltages and frequencies of operation.

### SUMMARY OF THE INVENTION

According to a first preferred embodiment of the present invention, a winding arrangement for an electrical transformer is provided. The winding arrangement includes a primary coil and a secondary coil. The primary coil and the secondary coil each include a first section and a second section, and each of the first and second sections include a first set of turns having a first diameter and a second set of turns having a second diameter. The first diameter is larger than the second diameter. The first section and second section of the primary coil are electrically connected in parallel and are wound around a common winding axis, with the second set of turns of the second section positioned within the first set of turns of the first section, and the second set of turns of the first section positioned within the first set of turns of the second section, when viewed along the common winding axis. The first section and second section of the secondary coil are electrically connected in parallel and are also wound around the common winding axis, with the second set of turns of the second section positioned within the first set of turns of the first section, and the second set of turns of the first section positioned within the first set of turns of the second section, when viewed along the common winding axis. The turns of the primary coil are interleaved with the turns of the secondary coil.

Optionally, the primary coil is interleaved with the secondary coil such that each turn of the secondary coil is disposed between two turns of the primary coil when viewed along a direction perpendicular to the common winding axis.

Optionally, the primary coil is interleaved with the secondary coil such that the turns of the first set of turns of the primary coil and the turns of the first set of turns of the secondary coil alternate along the common winding axis, and the turns of the second sets of turns of the primary coil and the turns of the second sets of turns of the secondary coil alternate along the common winding axis.

Optionally, the primary coil is identical to the secondary coil.

Optionally, the secondary coil is rotated by 180° about the common winding axis relative to the primary coil.

Optionally, the winding arrangement further includes one or more additional secondary coils. The one or more additional secondary coils each include a first section and a second section, and each of the first and second sections include a first set of turns having the first diameter and a second set of turns having the second diameter. The first section and second section of each additional secondary coil are electrically connected in parallel and are wound around the common winding axis, with the second set of turns of the second section positioned within the first set of turns of the first section, and the second set of turns of the first section positioned within the first set of turns of the second section, when viewed along the common winding axis. The turns of the primary coil are interleaved with the turns of the one or more additional secondary coils.

Optionally, the primary coil is interleaved with the secondary coil and the one or more additional secondary coils such that: each turn of the secondary coil is disposed between two turns of the primary coil when viewed along a direction perpendicular to the common winding axis, and each turn of the one or more additional secondary coils is disposed between two turns of the primary coil when viewed along the plane containing the common winding axis.

Optionally, the primary coil is interleaved with the secondary coil and the one or more additional secondary coils such that the turns of the first set of turns of the primary coil and the turns of the first set of turns of the secondary coil alternate along a first portion of the common winding axis, and the turns of the second sets of turns of the primary coil and the turns of the second sets of turns of the secondary coil alternate along the first portion of the common winding axis, and the turns of the first set of turns of the primary coil and the turns of the first set of turns of the one or more additional secondary coils alternate along a second portion of the common winding axis, and the turns of the second sets of turns of the primary coil and the turns of the second sets of turns of the one or more additional secondary coils alternate along the second portion of the common winding axis.

Optionally, the number of turns in the primary coil is greater than or equal to the combined total number of turns in the secondary coil and the one or more additional secondary coils.

Optionally, the winding arrangement includes up to nine additional secondary coils.

Optionally, the secondary coil and the one or more additional secondary coils are stacked such that the secondary coil and the one or more additional secondary coils fully overlap when viewed along the common winding axis.

Optionally, the primary coil and the secondary coil fully overlap when viewed along the common winding axis.

Optionally, for each coil, the number of turns in the first set of turns of the first section and the number of turns in the first set of turns of the second section of are equal, and the number of turns in the second set of turns of the first section and the number of turns in the second set of turns of the second section of are equal.

Optionally, for each section of each coil the number of turns in the first set of turns is equal to the number of turns in the second set of turns of that section.

Optionally, the first sets of turns and the second sets of turns of each coil are concentric about the common winding axis.

Optionally, the turns of each of the coils includes a rectangular, square, or circular shape about the winding axis; and/or each set of turns is arranged helically around the common winding axis.

Optionally, each of the coils are formed from aluminum wire.

Optionally, each of the coils is formed from flat wire.

Optionally, the flat wire has a width of between 10 mm and 15 mm, and a thickness of between about 0.8 mm and about 1.2 mm, preferably a thickness of about 1 mm.

Optionally, each of the coils are encased in a potting material.

Optionally, each coil includes connection terminals extending parallel or substantially parallel to the direction of the common winding axis, for allowing an electrical connection to be made with that coil.

Optionally, the connection terminals of the primary coil and the connection terminals of the secondary coil or coils are located on opposing sides of the winding arrangement.

According to a second preferred embodiment of the present invention, a winding arrangement for an electrical transformer is provided. The winding arrangement includes a primary coil and plurality of secondary coils. The primary coil includes a first section and a second section, and each of the first and second sections include a first set of turns including a first diameter and a second set of turns including a second diameter. The first diameter is larger than the second diameter. The first section and second section of the primary coil are electrically connected in parallel and are wound around a common winding axis, with the second set of turns of the second section positioned within the first set of turns of the first section, and the second set of turns of the first section positioned within the first set of turns of the second section, when viewed along the common winding axis. Each of the plurality of secondary coils includes a first set of turns including the first diameter and a second set of turns including the second diameter, both wound around the common winding axis. The turns of the primary coil are interleaved with the turns of the plurality of secondary coils.

Optionally, the primary coil is interleaved with the secondary coils such that each turn of the plurality of secondary coils is disposed between two turns of the primary coil when viewed along a direction perpendicular to the common winding axis.

According to a third preferred embodiment of the present invention, an electrical transformer is provided. The electrical transformer includes a transformer core; and the winding arrangement of the first or second preferred embodiments arranged around the transformer core.

The winding arrangements of the first and second preferred embodiments reduce losses caused by the proximity effect, due to the interleaving of the primary and secondary coils. Moreover, the winding arrangements allow multiple secondary coils to be used, while retaining a compact structure and small footprint, allowing a transformer including the winding arrangement to power multiple circuits and/or provide redundancy in both high- and low-current situations. Lastly, when multiple secondary coils are used, series and parallel connections between the secondary coils can be tailored to allow the transformer to operate with the desired power over large voltage and frequency ranges.

According to a fourth preferred embodiment of the present invention, an electrical transformer is provided. The electrical transformer of the fourth preferred embodiment is described in the following clauses:
(1) An electrical transformer including a transformer core; a winding unit arranged around the transformer core, the winding unit including a primary coil and a secondary coil encased in a potting material; and a housing surrounding the transformer core and the winding unit, the housing including a plurality of thermally conductive sections in thermal contact with the winding unit and/or the transformer core, and the housing including one or more open sides such that the winding unit is exposed.
(2) The electrical transformer according to clause 1, wherein the housing includes two open sides located on opposing sides of the housing, to expose the winding unit at both of the opposing sides of the housing.
(3) The electrical transformer according to clause 2, wherein the two open sides expose a portion of each of the plurality of thermally conductive sections.
(4) The electrical transformer according to any preceding clause, wherein the transformer is cuboid or substantially cuboid in shape, and each open side extends across an entire face of the cuboid transformer.
(5) The electrical transformer according to any preceding clause, wherein the housing includes an upper panel and a lower panel disposed on opposing sides of the transformer.
(6) The electrical transformer according to clause 5, wherein the upper panel and lower panel extend in planes normal to a winding axis of the winding unit.
(7) The electrical transformer according to clauses 5 or 6, wherein the upper panel and lower panel are in contact with the transformer core.
(8) The electrical transformer according to any of clauses 5 to 7, wherein the plurality of thermally conductive sections includes a first set of thermally conductive sections that extend between the upper panel and the lower panel and are in thermal contact with the upper panel and lower panel.
(9) The electrical transformer according to clause 8, wherein each of the first set of thermally conductive sections is releasably secured to the upper panel at a first end, and releasably secured to the lower panel at a second end.
(10) The electrical transformer according to any of clauses 5 to 9, wherein the plurality of thermally conductive sections includes a second set of thermally conductive sections disposed between the upper panel and the winding unit, and in thermal contact with the upper panel and the winding unit; and/or the plurality of thermally conductive sections includes a third set of thermally conductive sections disposed between the lower panel and the winding unit, and in thermal contact with the lower panel and the winding unit.
(11) The electrical transformer according to clause 10, wherein: each of the second set of thermally conductive sections is releasably secured to the upper panel; and/or each of the third set of thermally conductive sections is releasably secured to the lower panel.
(12) The electrical transformer according to any of clauses 5 to 11, further including one or more additional thermally conductive sections disposed against a central portion of the transformer core, wherein each additional thermally conductive section extends between the upper panel and the lower panel and is in thermal contact with the upper panel and lower panel; wherein the winding unit is arranged around the transformer core and the additional thermally conductive sections.
(13) The electrical transformer according to clause 12, wherein the one or more additional thermally conductive sections are integral with the winding unit.
(14) The electrical transformer according to any of clauses 10 to 13, wherein: the housing includes gaps between the first set of thermally conductive sections and the third set of thermally conductive sections; and/or the housing includes gaps between the second set of thermally conductive sections and the one or more additional thermally conductive sections.
(15) The electrical transformer according to any preceding clause, wherein the transformer core includes one or more core layers, wherein each core layer includes two closed cores, and each closed core is constructed from either two U-shaped cores or from a U-shaped core and an I-shaped core; a thermally conductive plate that is disposed between the closed cores and extends along a winding axis of the winding unit so as to bisect the one or more core layers; and optionally, when the transformer core includes a plurality of core layers, one or more secondary thermally conductive plates disposed between the core layers.
(16) The electrical transformer according to any preceding clause, wherein the winding unit includes a pair of protrusions configured to engage with the transformer core, with a portion of the transformer core located between the protrusions when the winding unit is arranged around the transformer core.
(17) The electrical transformer according to clause 16, wherein the pair of protrusions extend between the winding unit and the lower panel.
(18) The electrical transformer according to clauses 16 or 17, wherein the pair of protrusions are formed from the potting material.
(19) The electrical transformer according to any preceding clause, wherein the plurality of thermally conductive sections prevent movement of the winding unit within the housing.
(20) The electrical transformer according to any preceding clause, wherein the winding unit includes a primary coil and a secondary coil, and wherein the primary coil and the secondary coil each include a first section and a second section, and each of the first and second sections include a first set of turns including a first diameter and a second set of turns including a second diameter; the first diameter is larger than the second diameter; the first section and second section of the primary coil are electrically connected in parallel and are wound around a common winding axis, with the second set of turns of the second section positioned within the first set of turns of the first section, and the second set of turns of the first section positioned within the first set of turns of the second section, when viewed along the common winding axis; the first section and second section of the secondary coil are electrically connected in parallel and are also wound around the common winding axis, with the second set of turns of the second section positioned within the first set of turns of the first section, and the second set of turns of the first section positioned within the first set of turns of the second section, when viewed along the common winding axis; and the turns of the primary coil are interleaved with the turns of the secondary coil.
(21) The electrical transformer according to any preceding clause, wherein the winding unit further includes a plurality of secondary coils, up to ten secondary coils.
(22) The electrical transformer according to any of clauses 5 to 21, wherein the winding unit includes connection points for the primary coil and secondary coil that extend through the upper panel.
(23) The electrical transformer according to any of clauses 5 to 22, wherein the lower panel is a cold plate, or is disposed in thermal contact with a cold plate.
(24) The electrical transformer according to any preceding clause, wherein one or more of the plurality of thermally conductive sections includes radiating fins.
(25) The electrical transformer according to any preceding clause, wherein one or more of the plurality of conductive sections are formed from aluminum; and/or one or more of the plurality of conductive sections includes at least one outer surface that is colored black.

The electrical transformer of the fourth preferred embodiment provides a number of advantages. The semi-open construction enhances the cooling of the transformer core and winding, while also reducing the weight and cost of the device. Moreover, the electrical transformer is modifiable after installation, thus providing an adaptable transformer that is applicable to many applications, and universal over power ratings in the range of about 50 kW to about 100 kW.

In particular, a simple change of the plurality of thermally conductive sections (between those with and without radiating fins) and/or a simple change of the lower panel (such as introducing a cooling plate) means that the transformer can be made suitable for various different forced air cooled, natural convention cooled, or water cooled plate mounted constructions. The winding arrangement can also be changed after initial installation. These modifications are easily performed by, for example, using releasable connections, helping to provide a universal transformer construction.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 shows an example of a known transformer.

FIG. 2A shows a transformer according to a preferred embodiment of the present invention.

FIG. 2B shows the transformer core and winding unit of the transformer of FIG. 2A in isolation.

FIG. 3A shows the transformer of FIG. 2A with the upper panel removed.

FIG. 3B shows a plan view of FIG. 3A.

FIG. 3C shows a side view of the transformer of FIG. 2A.

FIG. 3D shows a second side view of the transformer of FIG. 2A.

FIG. 3E shows a bottom view of the transformer of FIG. 2A.

FIG. 3F shows a bottom view of the transformer of FIG. 2A with the lower panel removed.

FIG. 4 shows a winding unit in another preferred embodiment of the present invention.

FIG. 5 shows a transformer according to a preferred embodiment of the present invention.

FIG. 6 shows a transformer core according to another preferred embodiment of the present invention in isolation.

FIG. 7A shows a winding arrangement in a preferred embodiment of the present invention.

FIG. 7B shows a first section of a coil of a preferred embodiment of the present invention.

FIG. 7C shows a second section of a coil of a preferred embodiment of the present invention.

FIG. 7D shows an alternative view of the second section of FIG. 7C.

FIG. 7E shows a coil of a preferred embodiment of the present invention.

FIG. 7F shows a cross sectional view of the winding arrangement of FIG. 7A.

FIG. 8A shows a winding arrangement in a preferred embodiment of the present invention.

FIG. 8B shows an alternative view of the winding arrangement of FIG. 8A.

FIG. 9A shows a first section of a secondary coil of a preferred embodiment of the present invention.

FIG. 9B shows an alternative view of the first section of FIG. 9A.

FIG. 9C shows a second section of a secondary coil of a preferred embodiment of the present invention.

FIG. 9D shows an alternative view of the second section of FIG. 9C.

FIG. 9E shows two secondary coils of a preferred embodiment of the present invention.

FIG. 10A shows four secondary coils of a preferred embodiment of the present invention.

FIG. 10B shows nine secondary coils of a preferred embodiment of the present invention.

FIG. 10C shows ten secondary coils of a preferred embodiment of the present invention.

FIG. 11A shows two secondary coils of a preferred embodiment of the present invention.

FIG. 11B shows two secondary coils of a preferred embodiment of the present invention.

FIG. 11C shows two secondary coils of a preferred embodiment of the present invention.

FIG. 12A shows four secondary coils of a preferred embodiment of the present invention.

FIG. 12B shows nine secondary coils of a preferred embodiment of the present invention.

FIG. 12C shows ten secondary coils of a preferred embodiment of the present invention.

FIG. 12D shows an alternative view of the ten secondary coils of FIG. 12C.

FIG. 13 shows a cross sectional view of a winding material in a preferred embodiment of the present invention.

FIG. 14 is a graph showing the maximum operating power of an electrical transformer according to preferred embodiments of the present invention.

### DETAILED DESCRIPTION OF THE PREFERRED EMBODIMENTS

### Transformer Construction

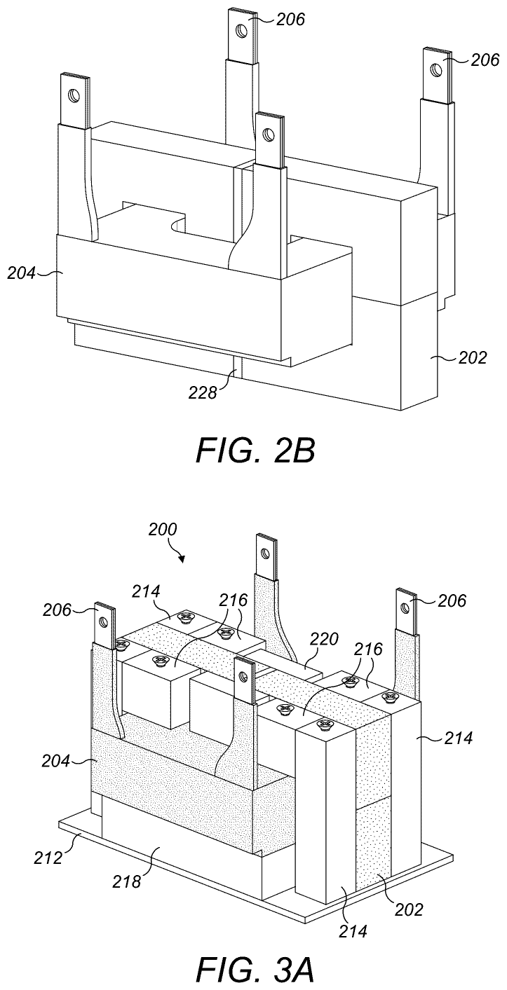

FIG. 2A shows a transformer 200 according to a first preferred embodiment of the present invention. The transformer 200 includes a transformer core 202 and a winding unit 204 arranged around the transformer core (both shown shaded in FIG. 2A). The transformer 200 further includes a mounting arrangement, referred to herein as a housing 208 surrounding the transformer core 202 and the winding unit 204. The housing 208 includes an upper panel 210 and a lower panel 212, and includes a plurality of thermally conductive sections 214, 216, 218 in thermal contact with the winding unit 204 and the transformer core 202, as will be explained in more detail below.

The transformer 200 can be a high-frequency transformer, a high-voltage transformer, a high-power transformer, a high-power, high-frequency transformer, a high-voltage high-frequency high-power transformer, or the like. A single-phase shell-type transformer is considered in FIGS. 2A and 2B and throughout this specification; however, preferred embodiments of the present invention could also be applied in multiphase shell-type transformers and multiphase core type transformers.

FIG. 2B shows the transformer core 202 and a winding unit 204 in isolation. The transformer core 202 includes a UU type core constructed from four U-shaped cores. Although UU type cores will be used as the main example throughout this description, UI type cores could also be used as an alternative, or in combination with UU type cores. The UU core construction can alternatively be achieved with EI arrangements as well as UI arrangements. Two U-shaped cores are combined to create a closed core. Two closed cores are then combined side by side to construct a core layer. When only U-shaped cores are used, each core layer will include four U-shaped cores, as shown in FIG. 2B. However, more than two core layers could be used in some preferred embodiments, with multiple core layers stacked together, as shown in FIG. 6 later. Therefore, in general, the number of U-shaped cores used varies in multiples of four, depending on the application. Multiple core layers are typically used at higher power levels. The U-shaped cores are made from a magnetic material such as a ferrite material. An optional thermally conductive plate 228 may also be included in the transformer core 202, as will be explained in more detail later.

The winding unit 204 includes at least one primary coil and one or more secondary coils encased in a potting material. The coils in the winding unit 204 share a common winding axis. The winding unit 204 is arranged around the transformer core 202. Specifically, the winding unit 204 surrounds the central portion (the middle strut) of the transformer core as shown in FIG. 2B. Each coil within the winding unit 204 is therefore wound around the central portion of the transformer core 202. Connection terminals 206 extend out of the potting material, for allowing an electrical connection to be made with the coils within the winding unit 204. The connection terminals 206 may extend in a direction parallel or substantially parallel to the winding axis of the winding unit 204 (perpendicular or substantially perpendicular within manufacturing and/or measurement tolerances to the plane of the winding unit 204).

A number of different winding arrangements could be used for in the winding unit 204. For example, round wire windings, flat wire windings, or even litz wire may be used. The windings may be formed from square or substantially square turns. The winding unit 204 as a whole including the potting material may therefore a be a square toroidal (donut) shape, as shown in FIG. 2B. The windings may be Murata's pdqb type windings, as detailed in UK patent application GB2574481A and international patent application publication WO 2019/234453 A1, which are hereby incorporated by reference in their entirety.

Alternatively, other winding arrangements could be used. More than one set of windings may be used in the winding unit 204, and each set of windings may contain a number of different coils, for example a primary and one or more secondary coils. The windings in the winding unit 204 may be insulated and protected due to the potting material. The potting material may be cast resin or epoxy or the like. Other transformer grade potting materials can be used, including silicon. The potting material can have a temperature class of class H or higher. However, for certain applications Class B or Class F potting materials may also be used.

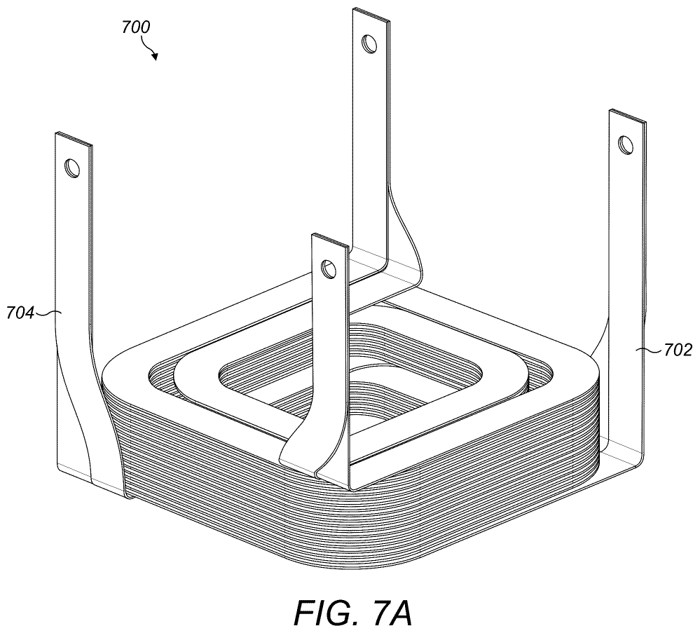

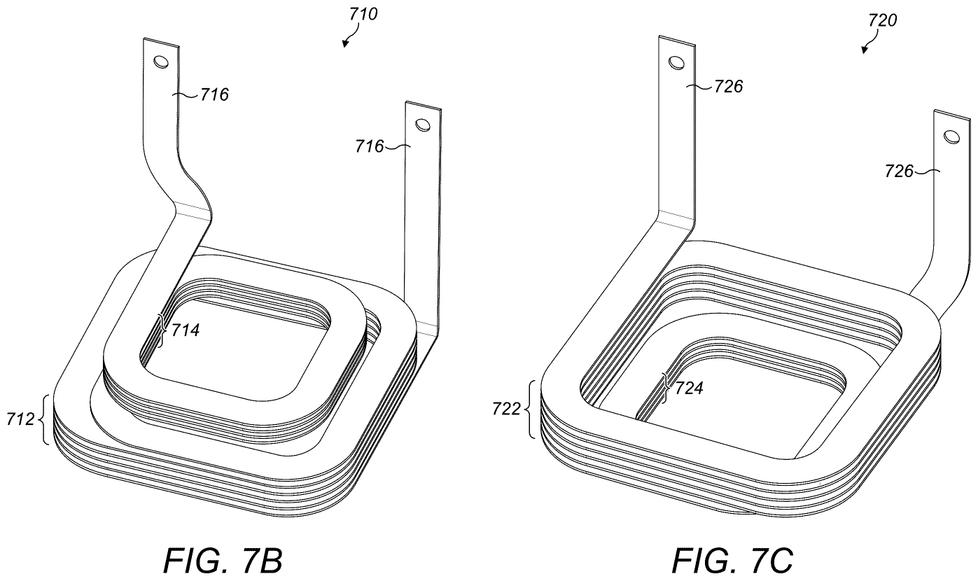

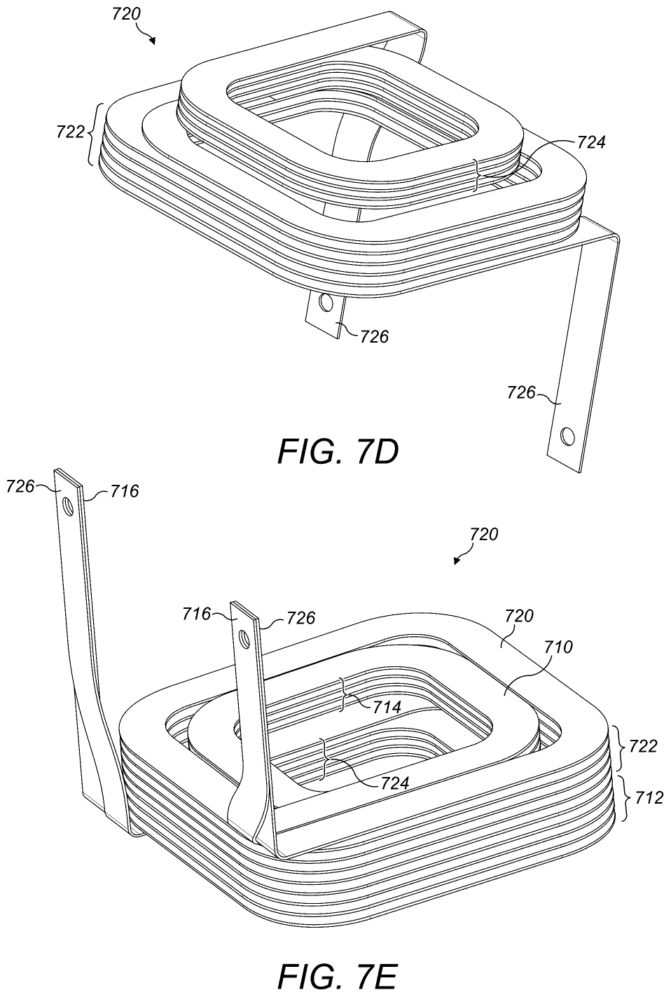

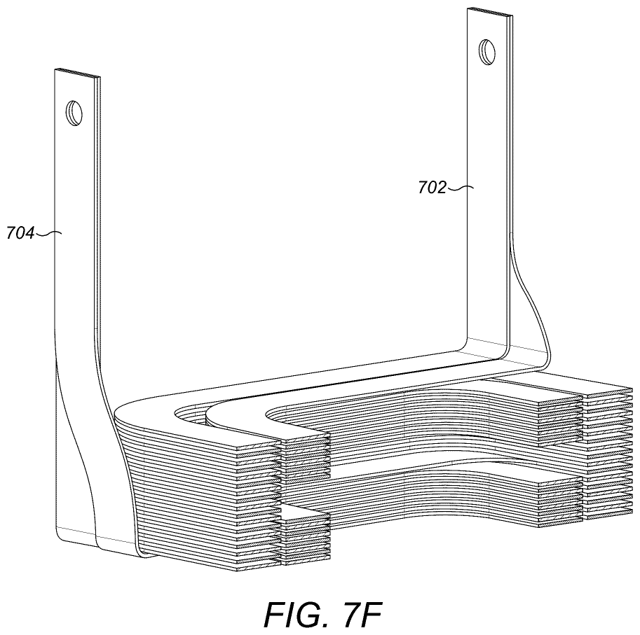

In general, any winding configuration may be used with the transformer core 202 and housing 208. Specific configurations of possible winding arrangements in some preferred embodiments of the present invention will be discussed in more detail later in FIG. 7A onwards.

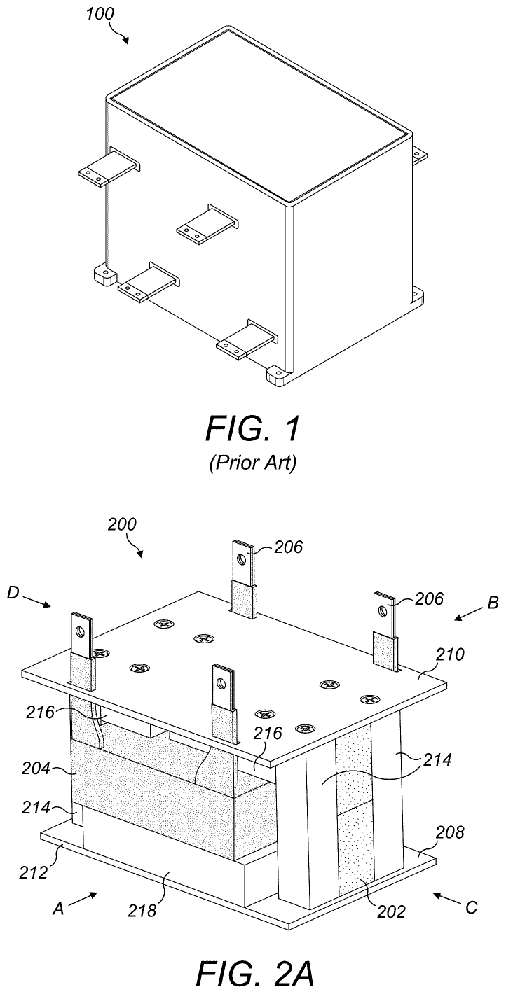

Returning to FIG. 2A, the housing includes one or more open sides such that the winding unit 204 is exposed. In other words, the winding unit 204 is not contained within a fully enclosed housing, unlike the transformer 100 of FIG. 1. Instead, the housing 208 is not fully enclosed in preferred embodiments of the present invention, but instead acts as a mounting arrangement for the transformer core 202 and the winding unit 204.

In the present preferred embodiment, the housing includes two open sides, marked by arrows A, BA, B in FIGS. 2A and 2B, that expose the winding unit 204. The two open sides A, BA, B are located on opposing sides of the housing. The transformer 200 of FIG. 2A is cuboid or substantially cuboid in shape, with the two open sides A, BA, B on opposing faces of the cuboid. Each open side may extend across an entire face of the cuboid shaped transformer. A typical size of the transformer 200 in a specific preferred embodiment is about 200 mm by 140 mm by 110 mm, however various other dimensions are possible. In the specific example given, each of the open sides A, B therefore includes an area of about 200 mm by about 140 mm within manufacturing and/or measurement tolerances. However, in some preferred embodiments, the open sides may extend over only a portion of a given face of the transformer 200. Moreover, in some preferred embodiments, only one of the sides marked A and B in FIG. 2A may be open so as to expose the winding unit 204 at that side only.

This semi-open construction has a number of benefits. Rather than the entire transformer being encased in a potting material, the hybrid construction where only the winding unit 204 is encased in a potting material results in a reduced weight and manufacturing cost. Moreover, cooling for the winding unit 204 is improved by allowing portions of the winding unit 204 to be exposed to the surrounding air, without including a completely exposed coils (i.e. an unpotted winding unit) and the associated challenges that such a configuration would present (for example movement of the coils, insulation, and vulnerability to damage). The semi-open construction of preferred embodiments of the present invention is specifically configured to optimize the trade-off between enhanced cooling and reduced weight versus retaining the structural integrity of the transformer.

In more detail, the housing 208 includes an upper panel 210 and a lower panel 212 disposed on opposing sides of the transformer. The upper and lower panels 210, 212 both extend in planes normal to a winding axis of the winding unit 204. In other words, the upper panel 210 is located on the top surface of the transformer 200 in FIG. 2A, and the lower panel 210 is located on the bottom surface of the transformer 200 in FIG. 2A. The open sides A, B of the transformer 200 that expose the winding unit 204 may be adjacent to the upper panel 210 and lower panel 212, and may extend between the upper and lower panel 210, 212. For example, in the preferred embodiment shown in FIG. 2A, the two open sides A, B of the housing extend between upper panel 210 and the lower panel 212 along faces on opposing sides of the device that are perpendicular or substantially perpendicular within manufacturing and/or measurement tolerances to the upper and lower panels 210, 212.

The upper and lower panels 210, 212 are in contact with the transformer core 202 on the top and bottom sides of the transformer 200. The remaining four sides of the transformer 200 do not include panels in the preferred embodiment shown in FIG. 2A. Therefore, in the present preferred embodiment there are in fact four open sides (four sides not covered by any panels). The winding unit 204 is exposed at the two opposing open sides A, B as mentioned above. The transformer core 202 is exposed at the other two opposing open sides, marked C and D in FIGS. 2A and 2B, that do not include panels. In other words, in the preferred embodiment shown in FIG. 2A in which the transformer is substantially a cuboid shape, the two opposing sides A, B that expose the winding unit 204, the two opposing sides C, D that expose the transformer core 202, and the upper and lower panels 210, 212 are mutually orthogonal.

In general, of the four open sides A, B, C, D shown in FIG. 2A (the four sides other than those covered by the upper and lower panels 210, 212), one or both of the sides marked A and B in FIG. 2A may be open so as to expose the winding unit 204, and one or both or neither of the sides marked C and D in FIG. 2A may be open so as the expose the transformer core 202. The preferred embodiment of FIG. 2A includes all four of these sides open, which provides maximal cooling for the transformer 200, as will be discussed below.

The upper and lower panels 210, 212 may be formed from sheets of material with a high thermal conductivity that will not disrupt the magnetic properties of the transformer, for example a non-magnetic metal could be used, such as aluminum or copper. In some preferred embodiments, alternative materials may be used for the upper panel 210, such as a non-metallic material. The connection terminals 206 for the primary coil and secondary coil may extend through the upper panel 210, to allow ease of access.

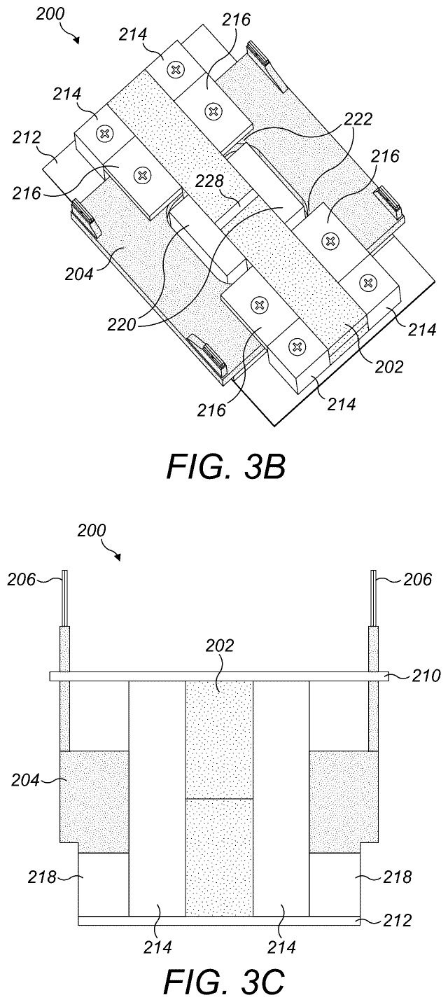

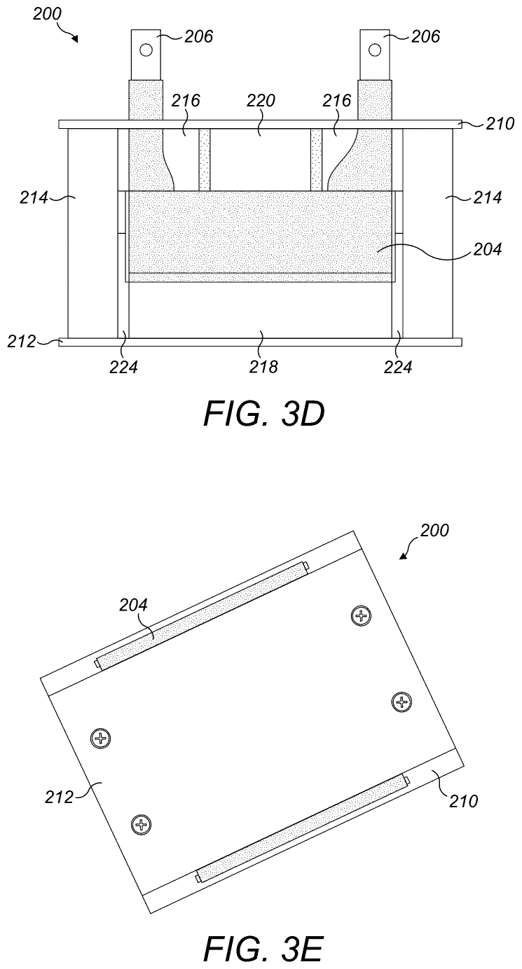

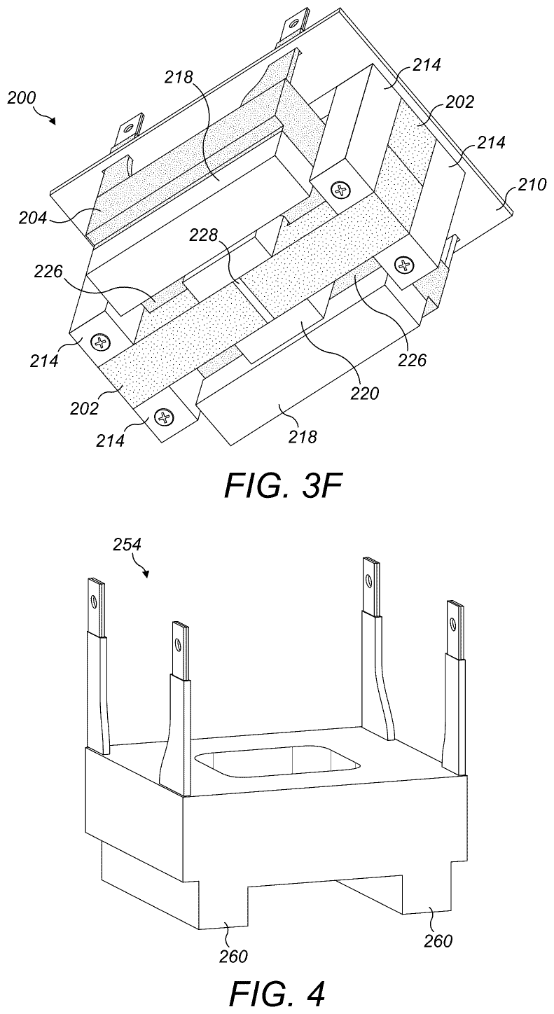

FIGS. 3A to 3F show the housing 208 of the preferred embodiment of FIG. 2A in more detail. FIG. 3A shows the transformer 200 of FIG. 2A with the upper panel 210 removed. FIG. 3B shows a plan view of FIG. 3A. FIG. 3C shows a side view of the transformer 200 of FIG. 2A. FIG. 3D shows a second side view of the transformer 200 of FIG. 2A. FIG. 3E shows a bottom view of the transformer 200 of FIG. 2A. FIG. 3F shows a bottom view of the transformer 200 of FIG. 2A with the lower panel 212 removed.

As can be seen from FIGS. 2A and 3A to 3F, the transformer 200 includes a plurality of thermally conductive sections 214, 216, 218 in thermal contact with the winding unit 204 and the transformer core 202. The thermally conductive sections 214, 216, 218 may be blocks of thermally conductive material. The plurality of thermally conductive sections 214, 216, 218 include a first set of thermally conductive sections 214, a second set of thermally conductive sections 216, and a third set of thermally conductive sections 218.

The first set of thermally conductive sections 214 extend between the upper panel 210 and the lower panel 212 and are in thermal contact with the upper panel and lower panel. Each of the first set of thermally conductive sections 214 is also positioned in thermal contact with the transformer core 202 and the winding unit 204. The first set of thermally conductive sections 214 includes four thermally conductive sections located towards the four corners of the lower panel 212. In other words, two of the first set of thermally conductive sections 214 are located on one side of the winding unit 204, with the transformer core 202 positioned between those two thermally conductive sections 214, and the other two of the thermally conductive sections 214 are located on the opposing side of the winding unit 204, also on either side of the transformer core 202. Each of first set of thermally conductive sections 214 extend in a lengthwise direction parallel or substantially parallel within manufacturing and/or measurement tolerances to the winding axis of the winding unit 2014.

The second set of thermally conductive sections 216 are disposed between the upper panel 210 and the winding unit 204 and are in thermal contact with both the upper panel 210 and the winding unit 204. The second set of thermally conductive sections 216, as best seen in FIG. 3B, are located between the upper surface of the winding unit 204 and the lower surface of the upper panel 210. The second set of thermally conductive sections 216 includes four thermally conductive sections in the present preferred embodiment, with each being in thermal contact with a respective one of the first set of thermally conductive sections 214.

The third set of thermally conductive sections 218 are disposed between the lower panel 212 and the winding unit 204, and in thermal contact with the lower panel 212 and the winding unit 204. The third set of thermally conductive sections 218 are located between the lower surface of the winding unit 204 and the upper surface of the lower panel 212. The third set of thermally conductive sections 218 includes two thermally conductive sections in the present preferred embodiment. Each of the third set of thermally conductive sections 218 extends in a lengthwise direction parallel or substantially parallel within manufacturing and/or measurement tolerances to the plane of the core layer in the transformer core 202, and perpendicular or substantially perpendicular within manufacturing and/or measurement tolerances to the winding axis of the winding unit 204. The third set of thermally conductive sections 218 are best seen in FIG. 3F.

Each of the plurality of thermally conductive sections 214, 216, 218 performs a number of functions.

First, the plurality of thermally conductive sections 214, 216, 218 retain the winding unit 204 within the housing 208 and prevent any movement of the winding unit 204 within the housing 208. All degrees of freedom of the winding (movement in any direction) is prevented by the plurality of thermally conductive sections 214, 216, 218.

Second, the plurality of thermally conductive sections 214, 216, 218 extract heat from the transformer core 202 and the winding unit 204. Each of the plurality of thermally conductive sections 214, 216, 218 is positioned in thermal contact with the transformer core 202 and/or the winding unit 204, depending on the specific preferred embodiment. In the preferred embodiment of FIGS. 2A and FIGS. 3A to 3F, each of the first and second sets of thermally conductive sections 214, 216 is in thermal contact with both the transformer core 202 and the winding unit 204, and each of the third set of thermally conductive sections 218 is in thermal contact with the winding unit 204.

Heat from the transformer core 202 and the winding unit 204 is transferred to the plurality of thermally conductive sections 214, 216, 218 through conduction. This heat extracted by the plurality of thermally conductive sections 214, 216, 218 can be removed via various different cooling structures, which will be discussed later. The plurality of thermally conductive sections 214, 216, 218 therefore act as cooling channels within the housing 208.

The plurality of thermally conductive sections 214, 216, 218 provide effective removal of heat from the interior of the transformer 200e. This allows the correct temperature levels to be maintained inside the transformer 200, which prevents damage or failure of the transformer 200 from occurring.

Some or all of thermally conductive sections may be exposed as well as the winding unit 204, due to the one or more open sides. In the present preferred embodiment, the two open sides A, B that expose the winding unit 204 also expose a portion of each of the plurality of thermally conductive sections 214, 216, 218. This allows and airflow to reach the plurality of thermally conductive sections 214, 216, 218 to aid cooling, as will be discussed in more detail below. The two open sides C, D that expose the transformer core 202 also expose a portion of the first set of thermally conductive sections 214.

The plurality of thermally conductive sections 214, 216, 218 can be made from a material with a high thermal conductivity that will not disrupt the magnetic properties of the transformer, for example a non-magnetic metal could be used, such as aluminum or copper. Each of the plurality of thermally conductive sections 214, 216, 218 may be made out of the same material, or out of various different materials. Blocks of aluminum can be used as the plurality of thermally conductive sections 214, 216, 218, due to the lightweight properties of aluminum.

The housing 208 may be releasably secured together. In particular, some or all of the plurality of thermally conductive sections 214, 216, 218 may be releasably secured to the upper and/or lower panels 210, 212.

In the present preferred embodiment, each of the first set of thermally conductive sections 214 is releasably secured to the upper panel 210 at a first end of the thermally conductive section 214, and releasably secured to the lower panel 212 at a second end of the thermally conductive section 214. Each of the second set of thermally conductive sections 216 is releasably secured to the upper panel 210. Each of the third set of thermally conductive sections 218 is releasably secured to the lower panel 212.

In the present preferred embodiment, the plurality of thermally conductive sections 214, 216, 218 are releasably secured using screw attachments. This is shown in FIGS. 3A, 3B and 3E for the first and second sets of thermally conductive sections 214, 216. The screws are not shown for the third set of thermally conductive sections 218 in the figures, however, may be included in some preferred embodiments. Other releasably securing structures may also be used, such as clips, nails, bolts, or the like.

The releasable connections between the upper and lower panels 210, 212 and the plurality of thermally conductive sections 214, 216, 218 mean that the transformer housing 208 can be easily dismantled and reassembled. This means that the configuration of the transformer housing 208 can be modified after installation, creating a more versatile transformer which may be applied to various different applications.

Optionally, the transformer 200 can include one or more additional thermally conductive sections 220, best seen in FIG. 3A. In the present preferred embodiment, two additional thermally conductive sections 220 are included. The additional thermally conductive sections 220 are disposed against the central portion of the transformer core 202, on either side of the core layer. Each of the additional thermally conductive section 220 extends between the upper panel 210 and the lower panel 212 and is in thermal contact with the upper panel 210 and lower panel 212. The additional thermally conductive sections 220 may also be in thermal contact with the third set of thermally conductive sections 218 in some preferred embodiments, as shown in FIG. 3F. When the additional thermally conductive sections 220 are included, the winding unit 204 is arranged around both the central portion of the transformer core 202 and the additional thermally conductive sections 220.

The additional thermally conductive sections 220 perform a similar heat extraction function as the plurality of thermally conductive sections 214, 216, 218, and the description above for the plurality of thermally conductive sections 214, 216, 218 applies analogously. Namely, the additional thermally conductive sections 220 can be made from a material with a high thermal conductivity that will not disrupt the magnetic properties of the transformer. The additional thermally conductive sections 220 provide further improvements in the cooling of the transformer 202, as the additional thermally conductive sections 220 can extract heat from the most central portion of the transformer 200.

The additional thermally conductive sections 220 may also be attached to the upper panel 210 and/or lower panel 212 by a releasably securing structure, such as a screw. Alternatively, the additional thermally conductive sections 220 may be held in position by a gluing or a tight fit arrangement. Moreover, the additional thermally conductive sections 220 may be incorporated into the potting material of the winding unit 204 in some preferred embodiments, as discussed in more detail later.

The housing 208 may include gaps 222 between the one or more additional thermally conductive sections 220 and the second set of thermally conductive sections 216, as best seen in FIG. 3B. The gaps 222 prevent any eddy current paths being formed due to stray leakage magnetic fields. In other words, the introduction of the gaps 222 in the heat conduction circuit formed by the plurality of thermally conductive sections 214, 216, 218 and the additional thermally conductive sections 220 avoids the formation of conductive paths through the heat conduction circuit. Such conductive paths can result in eddy currents which can cause high temperature rises and energy losses and could lead to shorting due to voltages induced by leakage magnetic fields.

The housing 208 may further include gaps 224 between the ends of each of the third set of thermally conductive sections 218 and the first set of thermally conductive sections 214. The gaps 224 also prevent eddy currents and shorting, similarly to the gaps 222. Due to the gaps 222 and gaps 224, an electrically conductive path round the perimeter of the transformer 200 through the plurality of thermally conductive sections 214, 216, 218 and the additional thermally conductive sections 220 is advantageously prevented.

In the preferred embodiment shown in FIGS. 2A to 3F, a winding unit 204 with a square toroidal shape is used (as shown in FIG. 2B) is used. When such a winding unit 204 is used, cavities 226 are present between the third set of thermally conductive sections 218 and the transformer core 202, best seen in FIG. 3F. If the additional thermally conductive sections 220 are included, the additional thermally conductive sections 220 extend into these cavities.

FIG. 4 shows an alternative winding unit 254, for use in another preferred embodiment of the present invention. The winding unit 254 is the same as the winding unit 204 in FIG. 2B, except that the winding unit 254 includes a pair of protrusions 260 which fill the cavities 226 shown in FIG. 3F. The pair of protrusions 260 engage with the transformer core 202 when the winding unit 254 is arranged around the transformer core 202, with a portion of the transformer core 202 located between the protrusions 260. In other words, a groove is formed between the protrusions 260, into which the transformer core 202 is seated. The interlocking between the protrusions 260 and the transformer core 202 means that the winding unit 204 is held securely in place, arranged around the transformer core 202, preventing any movement of the winding unit 204 within the housing 208.

When the winding unit 254 is fitted into the housing 208, the pair of protrusions 260 extend between the winding unit 254 and the lower panel 212. The pair of protrusions 260 may be formed from the potting material. In other words, the potting material surrounding the coils within the winding unit 254 and the potting material forming the protrusions 260 may be formed as one integral piece (formed as a single unit).

In some preferred embodiments, the protrusions 260 may themselves be releasably secured to the lower panel 212, in a similar fashion to the plurality of thermally conductive sections 214, 216, 218, for example by screw fixings. The protrusions 260 may include aluminum blocks molded into the potting material, into which a screw or the like can engage to couple the protrusions 260 to the lower panel 212. This can provide a strong mechanical fixing, with all the possible degrees of freedom of movement of the winding unit 254 restricted.

In both preferred embodiments of the winding unit 204 and 254, the winding unit may be formed by injection molding, specifically insert molding or overmolding. The coils in the winding unit are positioned into a mold, such as a Teflon or silicone mold, and then the potting material is cast into the mold to encase the coils, and optionally form the protrusions 260. The mold is then removed to leave the integrally formed winding unit 204, 254. The mold may be formed of two halves which can be disconnected from each other after the molding process, to release the finished winding unit 204, 254. Other methods of forming the winding unit 204, 254 are also possible.

In further preferred embodiments, when the one or more additional thermally conductive sections 220 are included, the one or more additional thermally conductive sections 220 may be formed integrally with the winding unit 204, 254. In other words, the one or more additional thermally conductive sections 220 may also be positioned within the mold prior to the introduction of the potting material, such that portions of the one or more additional thermally conductive sections 220 may be incorporated into (encased in) the potting material in the completed winding unit 204, 254. The additional thermally conductive sections 220 will then be integral with the winding unit 204, 254.

In the case of the winding unit 204 of FIG. 2B, when the additional thermally conductive sections 220 are integral with the winding unit 204, the central portion of each additional thermally conductive section 220 will be included within the potting material. In the case of the winding unit 254 of FIG. 4, the central portion of each additional thermally conductive section 220 will be included within the potting material, and the bottom portion of each additional thermally conductive section 220 (towards the lower panel 212) will be included in potting material of the protrusions 260.

Molding the winding unit together with the additional thermally conductive section 220 to form a single integral unit means that when the winding unit 204 is arranged around the transformer core 202, the additional thermally conductive sections 220 will be held securely against the central portion of the transformer core 202 by the potting material.

The above-described preferred embodiments provide a number of advantages. First, the hybrid semi-potted and open construction, where just the winding unit is potted and sides of the housing remain open, means that cooling air can reach the winding unit with ease. However, due to the potting material around the windings, the challenges associated with fully exposed windings, such as movement of the coils, insulation and vulnerability to damage, are negated.

Moreover, the reduction in the amount of potting material needed leads to a reduction in manufacturing costs, as well as a reduction in the weight of the device. For example, a typical dimension of the transformer 200 of the above preferred embodiments is about 200 mm by about 140 mm by about 110 mm within manufacturing and/or measurement tolerances. In transformers of this size, approximately 6 kg to approximately 7 kg of potting material can be removed due to the hybrid construction, compared to a comparably sized fully potted or enclosed transformer of the type shown in FIG. 1.

In addition, the above-described construction, particularly the plurality of thermally conductive sections 214, 216, 218 mean that the winding unit 204, 254 is securely held in a fixed position with respect to the transformer core 202 and housing 208, with all degrees of freedom of movement restricted. This ensures optimal performance of the device, as well as increasing durability.

Furthermore, the releasable securing of the various components of the housing 208 mean that the transformer 200 can be readily dismantled and reassembled, leading to a transformer 200 that is modifiable after construction. For example, the winding unit 204, 254 used in the transformer 200 may be removed and replaced with a different winding unit configuration. Moreover, the transformer 200 can easily be modified between different cooling arrangements, as outlined in more detail below. Therefore, the transformer 200 of the preferred embodiments described above provides a adaptable yet compact construction.

As well as holding the housing 208, and fixing the winding unit 204 in place, the plurality of thermally conductive sections 214, 216, 218 act as cooling channels, along with additional thermally conductive sections 220, to create a thermal conduction circuit. The thermal conduction circuit allows heat to be removed from the windings and the transformer core 202. The positions of the thermally conductive sections 214, 216, 218 are selected such that they provide the most efficient heat conduction paths from the hottest areas of the transformer 200 during operation.

The transformer 200 can be optimized for water cooling arrangement. For example, the transformer 200 can be cold plate mounted to remove the heat extracted by the plurality of thermally conductive sections 214, 216, 218 and the additional thermally conductive sections 220.

In one preferred embodiment, the lower panel 212 may be mounted onto a cold plate, so as to be in thermal contact with the cold plate. In another preferred embodiment, the lower panel 212 may itself be a cold plate. A cold plate may also be referred to as a cooling plate, and is typically water cooled. Heat is able to flow through the plurality of thermally conductive sections 214, 216, 218 and the additional thermally conductive sections 220, into the lower panel 212, to be removed from the transformer 200.

Other cooling methods are possible. For example, alternatively to the cooling plate arrangement described above, or in addition to the cooling plate arrangement, in some preferred embodiments, one or more of the plurality of thermally conductive sections 214, 216, 218 may include radiating fins. The radiating fins increase the surface area of the plurality of thermally conductive sections 214, 216, 218. These radiating fins may be cooled by forced air cooling or natural air cooling, to remove heat from the plurality of thermally conductive sections 214, 216, 218 that has been extracted from the winding unit 204, 254 and/or transformer core 202. The open sides of the housing 208 allow the airflow to reach the plurality of thermally conductive sections 214, 216, 218 in order to cool the radiating fins.

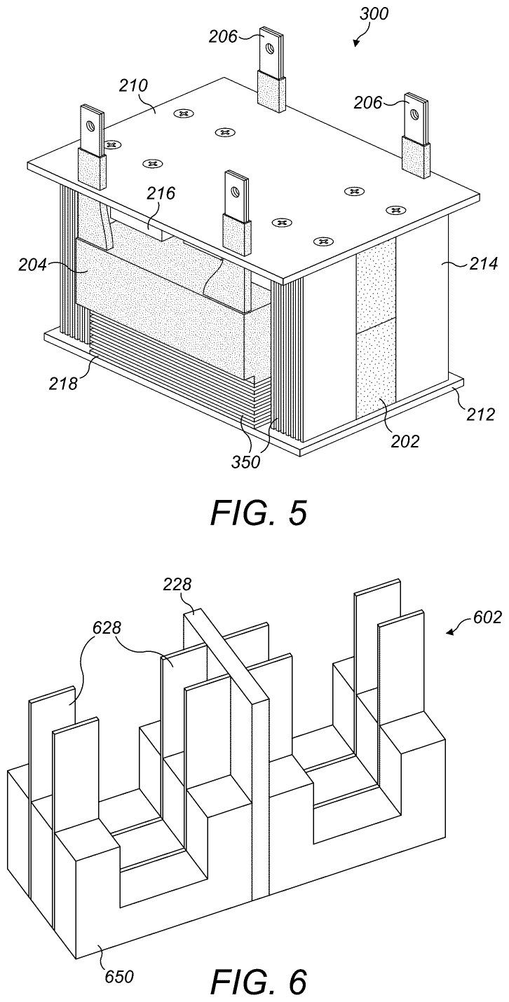

Radiating fins may be included on the outer surfaces of any or all of the plurality of thermally conductive sections 214, 216, 218. FIG. 5 shows one example of such a transformer 300, that includes radiating fins 350 on the first set of thermally conductive sections 214 and the third set of thermally conductive sections 218. The transformer 300 of FIG. 5 is identical to the transformer 200 of FIG. 2A, except for the addition of the radiating fins 350. In other preferred embodiments, the second set of thermally conductive sections 216 may also include radiating fins. The radiating fins may be located on any outer surface (any surface exposed to the air) of any of the plurality of thermally conductive sections 214, 216, 218.

The releasably secured connection between the components of the housing 208, particularly the plurality of thermally conductive sections 214, 216, 218 and the upper and lower panels 210, 212, means that the transformer 200, 300 can be easily swapped between different cooling configurations, for example attaching to different cooling plates, or swapping out thermally conductive sections without radiating fins for thermally conductive sections with radiating fins as necessary. In other words, a simple change of the plurality of thermally conductive sections 214, 216, 218 and/or lower panel 212 mean that the transformer 200, 300 can be made suitable for various different forced air cooled, natural convention cooled or water cooled plate mounted constructions. This modification is easily performed, for example, using the screw fastenings described in FIGS. 2A and 2B and 3A to 3F.

Typically, a cold plate will be used for transformers 200, 300 with a higher power, to provide active cooling of the transformer. Water cooled cold plates can therefore provide a considerable boost in the level of the power that can be derived from the transformer 200, 300 without overheating.

The transformer 200, 300 according to a preferred embodiment of the present invention is therefore compatible with almost all cooling techniques used in the industry for applications over various different power levels. The above-described transformer construction therefore provides a universal high-frequency transformer design that can be adapted to be used in almost all applications with a power rating in the range of about 50 kW to about 100 kW. Of course, the features of the preferred embodiments described above may also be applied to transformers with different power ratings.

Optionally, some or all of the plurality of thermally conductive sections 214, 216, 218 include at least one outer surface that is colored black. In some preferred embodiments, the entire surface of one or more of the thermally conductive sections 214, 216, 218 may be colored black. This coloring can lead to better heat radiation, and therefore improved cooling, due to the increase in black body radiation. In some preferred embodiments, the outer surfaces of the upper and lower panels 210, 212 may also be colored black.

In initial tests, coloring the thermally conductive sections 214, 216, 218 in a black color allowed the transformer to be used at approximately 5 kW higher power for the same temperature increase.

Returning to FIGS. 2A to 3F, the transformer core 202 may optionally include a thermally conductive plate 228 within the transformer core 202. Such thermally conductive plates are described in UK patent application publication GB2597670A and international patent application publication WO 2022/023744, which are hereby incorporated by reference in their entirety.

The thermally conductive plate 228 is best seen in FIG. 2B. The thermally conductive plate 228 is disposed between the closed cores in the single core layer of the transformer core 202 of FIG. 2B, and extends along the winding axis of the winding unit 204, 254 so as to bisect the core layer. The thermally conductive plate 228 is in contact with the upper and lower panels 210 and 212 at either end of the thermally conductive plate 228, and is also in thermal contact with the additional thermally conductive sections 220 if these are present. The thermally conductive plate 228 transfers heat away from the interior of the transformer core 202 via conduction, which can then be removed via the cooling structures discussed above. The thermal conductive plate 228 further improves the cooling of the transformer 200, 300.

FIG. 6 shows another example of a transformer core 602, that may be used in any of the previous preferred embodiments. The transformer core 602 includes a three core layers stacked together, and therefore includes twelve u-shaped cores 650 in total. The upper six u-shaped cores 650 have been omitted in FIG. 6, to allow the thermally conductive plates to be seen more clearly. The transformer core 602 includes a thermally conductive plate 228 between the closed cores, bisecting the core layers, similar to the thermally conductive plate 228 described above.

The transformer core 602 including multiple core layers may optionally include one or more secondary thermally conductive plates 628 disposed between the core layers, as shown in FIG. 6. The one or more secondary thermally conductive plates 628 are disposed between adjacent U-shaped cores, between the core layers, in a plane orthogonal to the plane of the (primary) thermally conductive plate 228, and parallel or substantially parallel, within manufacturing and/or measurement tolerances, to the axial direction of the windings. The secondary thermally conductive plates 628 are in contact with the upper and lower panels 210 and 212 at either end of the secondary thermally conductive plates 628. The secondary thermally conductive plates 628 further increase the amount of heat extracted from the transformer core 602, due to the increased contact area with the U-shaped cores 650.

The thermally conductive plates 228, 628 are positioned in planes which are parallel or substantially parallel within manufacturing and/or measurement tolerances to the magnetic field inside the transformer core 202, 602, so as to have no effect on the magnetic circuit. The thermally conductive plates 228, 628 can be made from a material with a high thermal conductivity that will not disrupt the magnetic properties of the transformer, such as aluminum. For example, a non-magnetic metal could be used, such as aluminum or copper.

Of course, in general various transformer core constructions may be used, with any number of core layers being included, and different combinations of the thermally conductive plates 228, 628.

### Winding Arrangement

A number of different windings arrangements according to preferred embodiments of the present invention will now be described. Each of the winding arrangements described below could be used in the winding units 204, 254 of any of the preferred embodiments of the transformers 200, 300 described above. Alternatively, the winding arrangements described below could also be used in any other type of electrical transformer.

FIG. 7A shows a winding arrangement 700 according to a preferred embodiment of the present invention. The winding arrangement is a pdqb-type winding but differs from the pdqb-type winding arrangements disclosed in UK patent application GB2574481A and international patent application publication WO 2019/234453 A1 in a number of ways. In particular, each coil in the winding arrangement 700 includes first and second sections connected in parallel, as described below.

The winding arrangement 700 includes a primary coil 702 and a secondary coil 704. The primary coil 702 includes a first section 710 and a second section 720. The first section 710 is shown in isolation in FIG. 7B, and the second section 720 is shown in isolation in FIG. 7C.

The first section 710 of the primary coil 702 includes a first set of turns 712 including a first diameter and a second set 714 of turns including a second diameter. The first set of turns 712 and second set of turns 714 are wound around a common winding axis, and each set of turns may include one or more individual turns. The first diameter is larger than the second diameter, such that when viewed along the common winding axis, the first and second set of turns are concentric with the second set of turns 714 located inside the diameter of the first set of turns 712.

The first section 710 is formed from a single integral piece of wire, to form a continuous electrically conductive path. In other words, a final turn of the first set of turns 712 is connected to a first turn of the second set of turns 714, as shown in FIG. 7B. The connection between the first set of turns 712 and the second set of turns 714 may be referred to as a cross-over portion. Connection terminals 716 may be included at each end of the wire of the first section 710, for allowing an electrical connection to be made with the first section 710 of the coil.

Similarly, the second section 720 of the primary coil 702 includes a first set of turns 722 including a first diameter and a second set 724 of turns including a second diameter smaller than the first diameter, with each set of turns including one or more individual turns and being arranged concentrically around a common winding axis. The first and second diameters of the second section 720 are the same as those for the first section 710. The first set of turns 722 and the second set of turns 724 of the second section 720 are also formed from a continuous piece of wire. FIG. 7D shows an alternative view of the underside of the second section 720 shown in FIG. 7C, to allow the connection (cross-over portion) between the first set of turns 722 and the second set of turns 724 to be seen more clearly. Connection terminals 726 may be included at each end of the wire of the second section 720, for allowing an electrical connection to be made with the second section 720 of the coil.

The first section 710 and second section 720 of the primary coil are electrically connected in parallel to form the primary coil 702. This electrical connection may be made via connecting or joining the connection terminals 716, 726 of each of the first and second sections 710, 720. In particular, the connection terminal 716 at a first end of the first section 710 and the connection terminal 726 at a first end of the second section 720 can be connected together, and the connection terminal 716 at a second end of the first section 710 and the connection terminal 726 at a second end of the second section 720 can be connected together.

FIG. 7E shows the full primary coil 702 constructed from the combined first and second sections 710, 720. The first and second sections 710, 720 are wound around the same common winding axis. Therefore, the first sets of turns 712 of the first section 710, the second set of turns 714 of the first section 710, the first sets of turns 722 of the second section 720, and the second set of turns 724 of the second section 720 are all arranged around the same common winding axis. Although formed from two coil sections, the combination of the first section 710 and the second section 720 forms a single primary coil 702, as shown in FIG. 7E.

In the primary coil 702, the second set of turns 724 of the second section 720 are positioned within the first set of turns 712 of the first section 710, and the second set of turns 714 of the first section 710 are positioned within the first set of turns 722 of the second section 720, when viewed along the common winding axis. By “positioned within” it is meant that the second set of turns 724 of the second section 720 are inside the first set of turns 712 of the first section 710, with both the second set of turns 724 and the first set of turns 712 located within the same plane extending perpendicularly or substantially perpendicular within manufacturing and/or measurement tolerances to the common winding axis. Similarly, the second set of turns 714 of the first section 710 are positioned within the first set of turns 722 of the second section 720 such that the second set of turns 714 are located inside the first set of turns 722 and both are located within the same plane extending perpendicularly or substantially perpendicularly within manufacturing and/or measurement tolerances to the common winding axis.

The first set of turns 712 of the first section 710 and the first set of turns 722 of the second section 720 fully overlap when viewed along the common winding axis, and the second set of turns 714 of the first section 710 and the second set of turns 724 of the second section 720 fully overlap when viewed along the common winding axis. In other words, the first and section seconds 710, 720 include the same footprint.

As well as the primary coil 702 described above, the winding arrangement 700 of FIG. 7A includes a single secondary coil 704. In the present preferred embodiment, the construction of the secondary coil 704 is the same as the primary coil 702. In other words, the secondary coil 704 also includes a first section 710 and a second section 720 connected in parallel and wound together, as described in relation to FIGS. 7B to 7E for the primary coil 702. The winding arrangement 700 shown in FIG. 7A is therefore constructed from two of the coils shown in FIG. 7E, with one acting as the primary coil 702 and one acting as the secondary coil 704. The primary coil 702 and secondary coil 704 are both wound around the same common winding axis. The primary coil 702 and the secondary coil 704 fully overlap when viewed along the common winding axis. In other words, the primary and secondary coils 702, 704 include the same footprint.

The winding arrangement 700 including both the primary and secondary coils 702, 704 is formed by interleaving the turns of the primary coil 702 with the turns of the secondary coil 704. The primary and secondary coils 702, 704 are interleaved such that each turn of the primary coil 702 (each turn of the first and second sets of turns 712, 714, 722, 724 of both the first and second sections 710, 720 of the primary coil 702) is positioned between two turns of the secondary coil 704 when viewed along a direction perpendicular to the common winding axis. Similarly, each turn of the secondary coil 704 is positioned between two turns of the primary coil when viewed along a direction perpendicular to the common winding axis. Put another way, each turn of the secondary coil 704 includes turns of the primary coil 702 located above and below the secondary coil turn.

In other words, along the direction of the common winding axis, the turns in the winding arrangement 700 alternate between the primary coil 702 and the secondary coil 704. Specifically, the turns of the first sets of turns 712, 722 of the primary coil 702 and the turns of the first sets of turns of the secondary coil 704 alternate along the common winding axis, and the turns of the second sets of turns 714, 724 of the primary coil 702 and the turns of the second sets of turns of the secondary coil 704 alternate along the common winding axis.

The interleaving of the primary and secondary coils 702, 704 is shown in FIG. 7F, which is a cross sectional view through the winding arrangement 700 of FIG. 7A. Different hatching patterns are used to distinguish the primary coil 702 and secondary coil 704 in the plane of the cross section.

Due to the above-described interleaving of the primary and secondary coils 702, 704, sections of the coils 702, 704 carrying currents in the same direction are not disposed directly adjacent to each other. This has the advantageous effect of reducing the losses caused by the proximity effect.

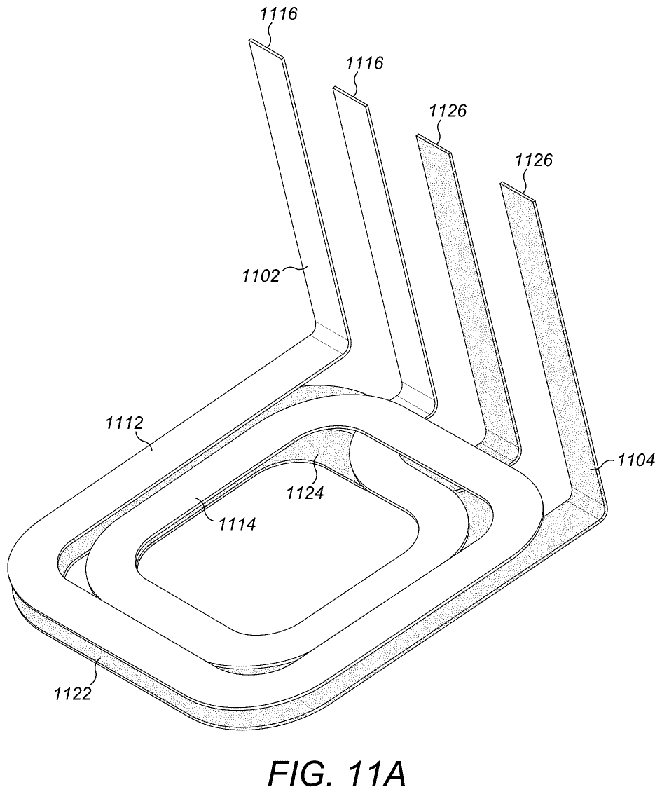

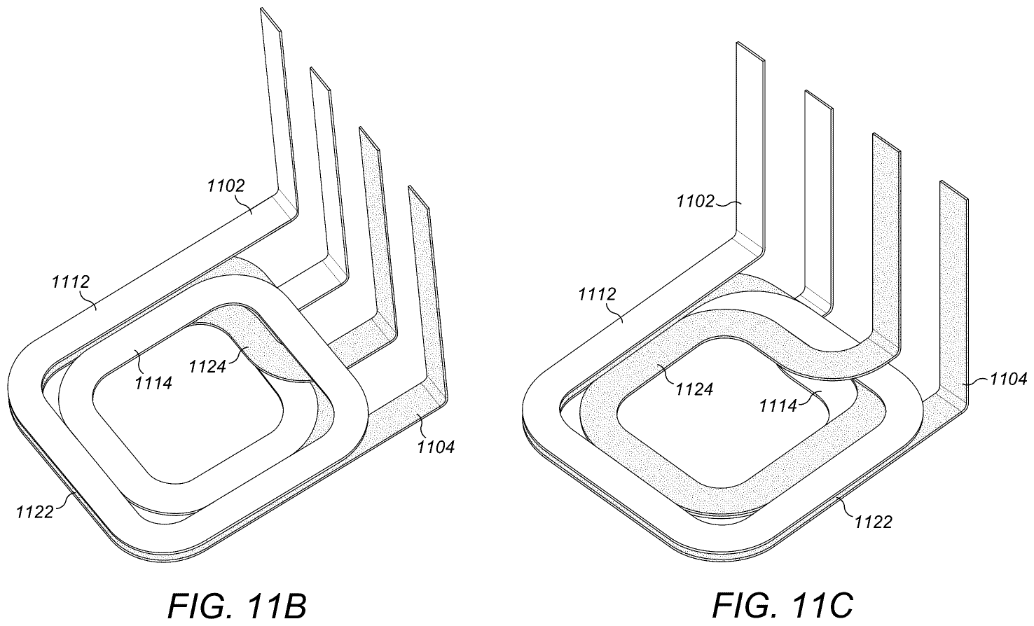

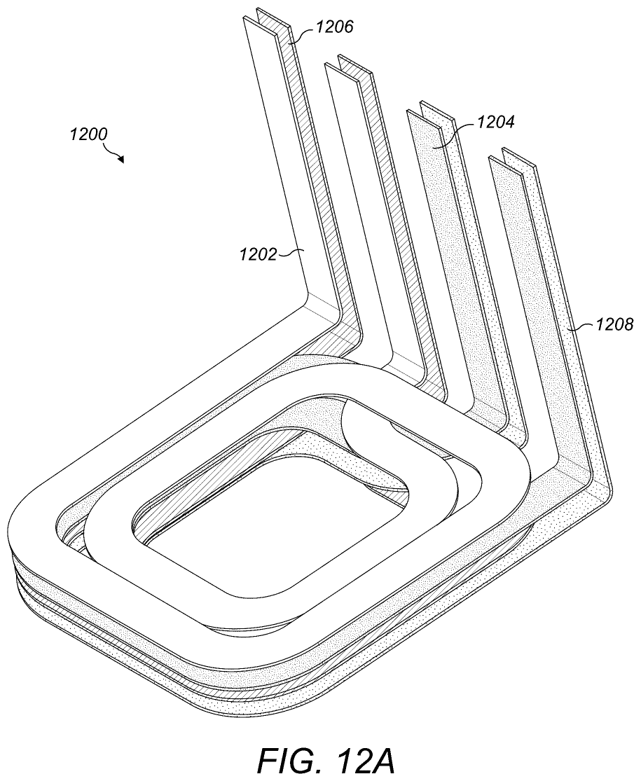

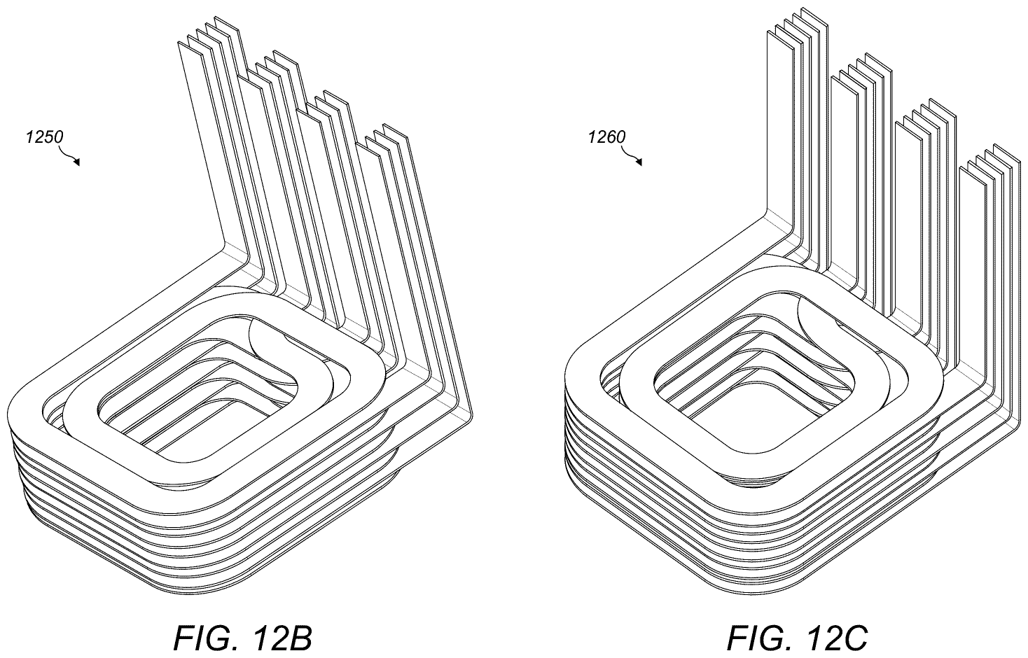

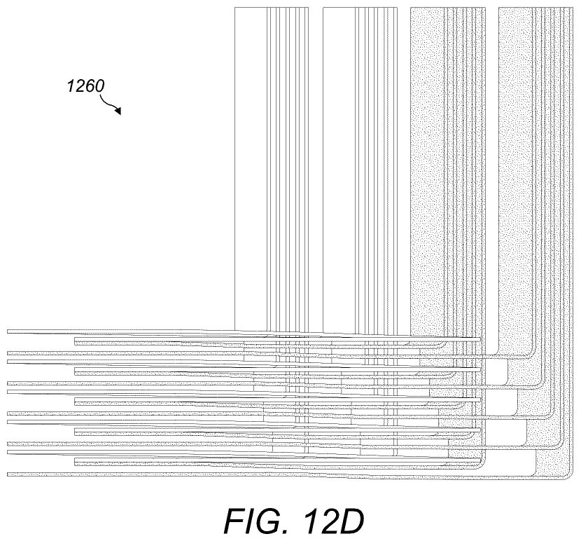

Moreover, the winding arrangement 700 is able to handle high currents due to the primary and secondary coils 702, 704 being formed from the two sections 710, 720 connected in parallel. This is because each section of each coil will only receive half the input current due to the parallel connection of the two sections. In some preferred embodiments the current level may be as high as approximately 1200 A. A winding arrangement suitable for low-current applications will be discussed in relation to FIGS. 11A to 12D.

For each of the primary coil 702 and the secondary coil 704 in the winding arrangement 700, the number of turns in the first set of turns 712, 722 of each of the first and second sections 710, 720 of that coil are equal, and the number of turns in the second sets of turns 714, 724 of each of the first and second sections 710, 720 of that coil are equal. In other words, for a given coil 702, 704, the first section 710 and second section 720 both include the same number of turns in their respective first set of turns 712, 722, and the first section 710 and second section 720 both include the same number of turns in their respective second set of turns 714, 724.

Therefore, the first section 710 of each coil 702, 704 is identical to the second section 720 of that coil, other than the folding direction of the connection terminals 716, 726 (best seen from a comparison of FIGS. 7B and 7D). This means that the first section 710 and second section 720 advantageously have the same impedance, due to including the same length conductive path and same shape. This also means that the total number of turns in the first section 710 of each coil is equal to the total number of turns in the second section 720 of that coil.

In some preferred embodiments, within each coil section 710, 720 there may be more turns in the first set of turns 712, 722 than in the second set of turns 714,274. For example, in the present preferred embodiment, as shown in FIGS. 7B and 7C, the first sets of turns 712, 722 each include six turns, and the second sets of turns 714,274 each include four turns. Alternatively, in each coil section 710, 720 the second set of turns 714,274 could include more turns that the first set of turns 712, 722 in some preferred embodiments. In a specific preferred embodiment, the number of turns in the first and second sets of turns may be equal. For example, in one preferred embodiment within each coil section 710, 720, the first set of turns 712, 722 may include five turns, and the second set of turns 714, 724 may include five turns. The number of turns may be tailored for the specific application.

Returning to FIG. 7A, in the winding arrangement 700 of the present preferred embodiment, the primary coil 702 and secondary coil 704 are identical, with same total number of turns in each coil (the total number of turns here being the combined number of turns in the first set of turns 712 of the first section 710, the second set of turns 714 of the first section 710, the first set of turns 722 of the second section 720, and the second set of turns 724 of the second section 720). In other preferred embodiments, the primary coil 702 and second coil 704 could include a different number of turns. Typically, the total number of turns in primary coil 702 would be greater than or equal to the total number of turns in the secondary coil 704.

In addition, in the preferred embodiment of the winding arrangement 700 shown in FIG. 7A, the connection terminals 716, 726 of the primary and secondary coils 702, 704 are also identical. The connection terminals 716, 726 for each section of each coil are folded so as to extend in a direction parallel or substantially parallel within manufacturing and/or measurement tolerances to the direction of the common winding axis. The connection terminals 716, 726 at each end of each coil 702, 704 are folded so that they all extend in the same direction away from the sets of turns of the coils 702, 704. For example, in the view of FIG. 7A, each of the connection terminals 716, 726 extend parallel or substantially parallel within manufacturing and/or measurement tolerances to the common winding axis in the upward direction in FIG. 7A.

The above-described folding configuration of the connection terminals 716, 726 has the advantage that each point of connection to the primary and secondary coils 702, 704 can be located on the same side of a transformer 200 including the winding arrangement. This is shown in the transformer 200 of FIG. 2A, in which the connection terminals 716, 726 of the winding arrangement 700 may be used as the connection terminals 206 of the transformer 200.

In alternative preferred embodiments, other folding configurations are possible for the connection terminals 716, 726. For example, the connection terminals 716, 726 could be folded in different directions to each other. For example, in one preferred embodiment, one or more of the connection terminals 716, 726 may be folded so as to extend along the common winding axis in one direction, and the remaining connection terminals 716, 726 may be folded so as to extend along the common winding axis in the opposing direction. In some preferred embodiments, the connection terminals 716, 726 could differ for each of the primary and secondary coils 702, 704. For example, the direction of extension of the connection terminals 716, 726 for the primary coil 702 may be in a different direction, for example, an opposing direction, to the extension of the connection terminals 716, 726 for the secondary coil 704. In some preferred embodiments, the connection terminals 716, 726 may extend along a direction other than the direction of the common winding axis. The folding configuration and direction of the connection terminals 716, 726 is chosen to locate the connection points to the coils 702, 704 at the desired position when the winding arrangement is used in a transformer device.

In the winding arrangement 700 of FIG. 7A, the connection terminals 716, 726 of the primary coil 702 and the connection terminals 716, 726 of the secondary coil 704 are located on opposing sides of the winding arrangement. In other words, the connection terminals 716, 726 of the primary coil 702 and the connection terminals 716, 726 of the secondary coil 704 are located on the opposite sides of a plane containing the common winding axis that bisects the winding arrangement. In the view of FIG. 7A, the connection terminals 716, 726 of the primary coil 702 are located on the right hand side of the drawing, and the connection terminals 716, 726 of the secondary coil 704 are located on the left hand side of the drawing. This configuration is advantageous as, when used in a transformer, the connection points of the primary and secondary coils may be more easily identified by the side that they are located at.

Put another way, the winding arrangement 700 of FIG. 7A is formed using two of the coils shown in FIG. 7E, with one acting as the primary coil 702, and one acting as the secondary coil 704. The secondary coil is rotated by 180° about the common winding axis relative to the primary coil 702, before the coils are interleaved, such that the connection terminals 716, 726 of the primary and secondary coils 702, 704 are located on opposing sides of the winding arrangement.

In an alternative preferred embodiment, the connection terminals 716, 726 of the primary and secondary coils 702, 704 may be located on the same side of the winding arrangement. In other words, the winding arrangement may be formed using two of the coils 702, 704 shown in FIG. 7E, without any rotation about the common winding axis between the two coils 702, 704. Other rotation angles may also be used, for example 90° and 270°.

In general, the turns of each of the coils 702, 704 in the winding arrangement 700 have a square shape about the winding axis. However a rectangular square, or circular shape, or various other shapes may also be used.

Each set of turns of each coil 702, 704 is arranged (wound) helically around the common winding axis. In other words, each coil 702, 704 is formed from a first helically wound first section 710 connected in parallel with a second helically wound second section 720.

When the winding arrangement 700 of FIG. 7A is used in winding units, such as winding units 204, 254 mentioned above in FIGS. 2A to 6, each of the primary coil 702 and secondary coil 704 may be encased in potting material.

### Multiple Secondary Coils

The winding arrangement of preferred embodiments of the present invention may also be used in applications with multiple secondary coils.

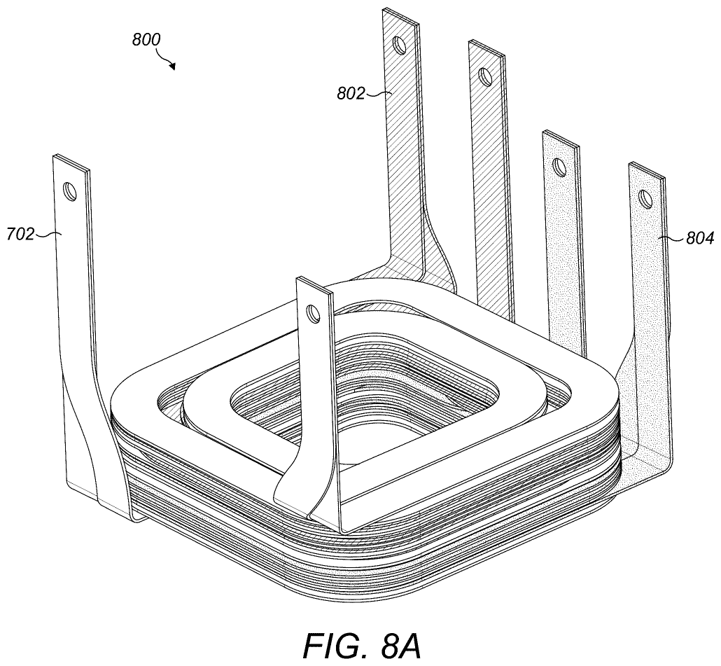

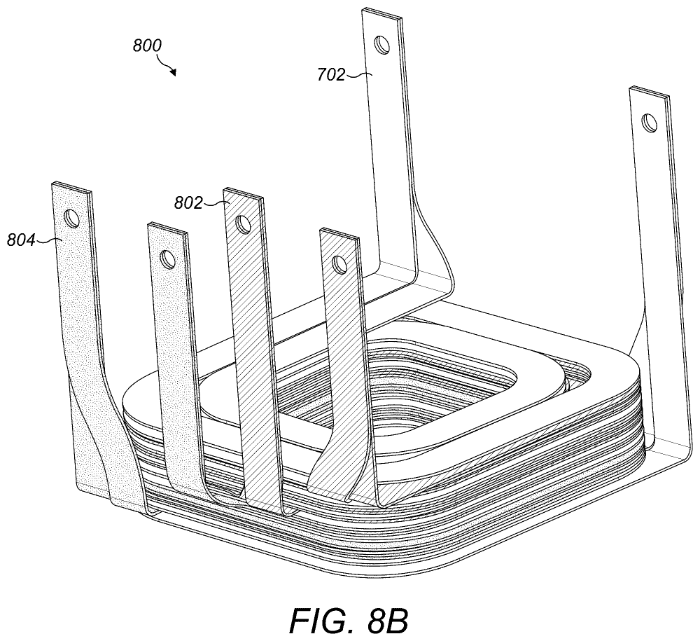

FIGS. 8A and 8B show front and rear perspective views of a winding arrangement 800 in a preferred embodiment of the present invention including two secondary coils. The winding arrangement 800 includes a primary coil 702 which is the same as the primary coil 702 described in relation to FIGS. 7A to 7F above, and shown in FIG. 7E. The winding arrangement further includes a first secondary coil 802 and an additional secondary coil 804, shown with different shading patterns in FIGS. 8A and 8B.

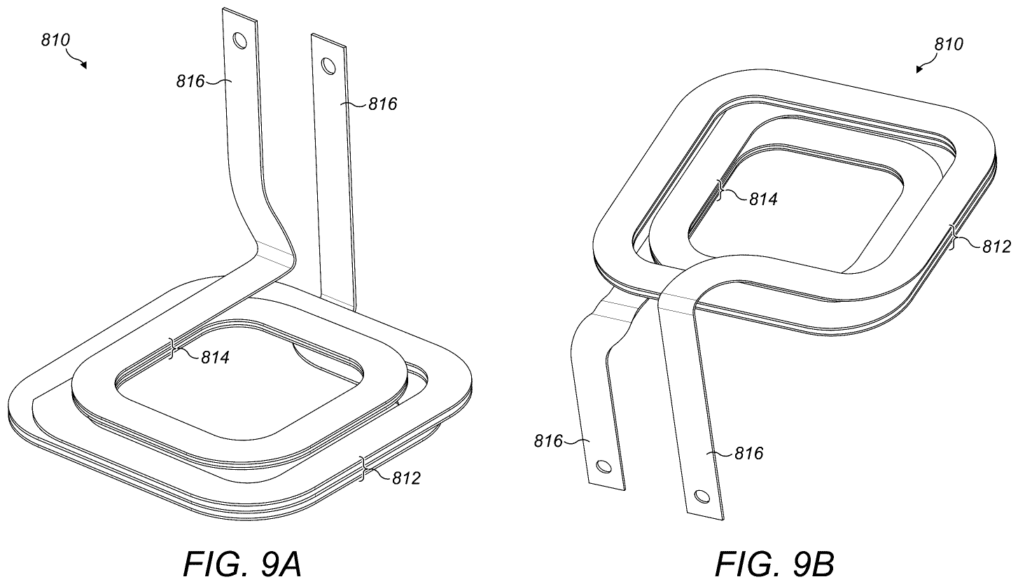

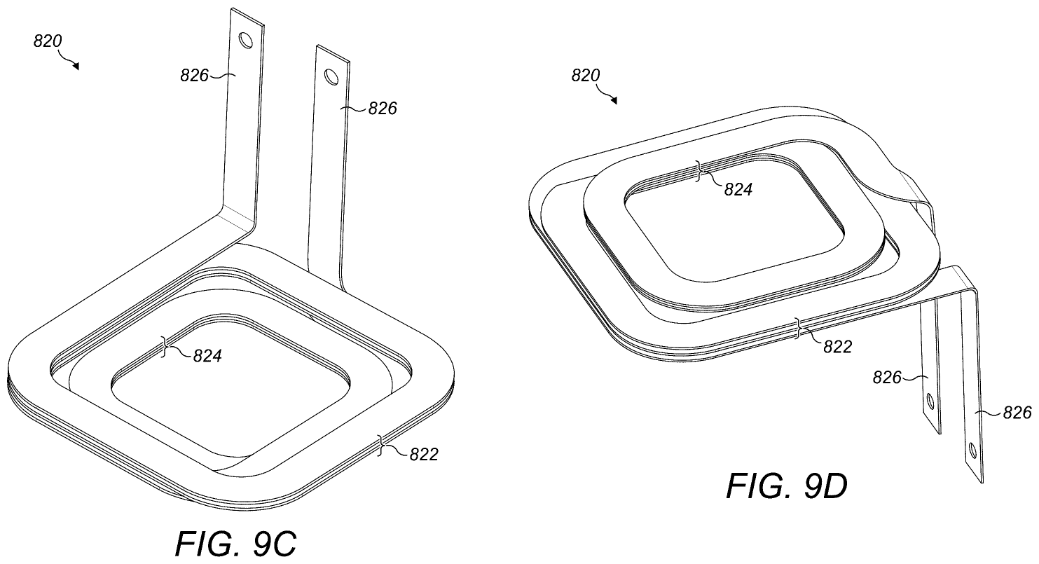

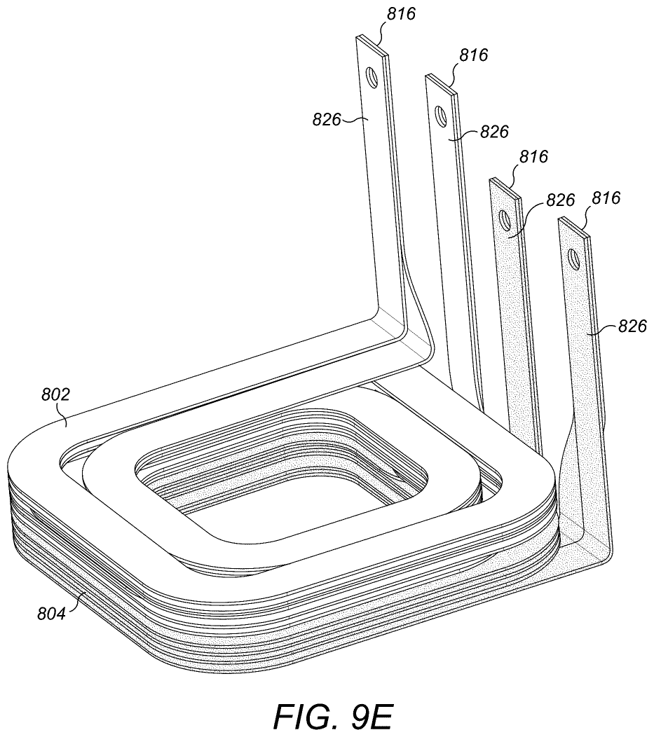

Each of the secondary coils 802, 804 include a first section 810 and a second section 820 connected in parallel and wound together around a common winding axis, in a similar manner to the primary coil 702. FIG. 9A shows a first section 810 of either of the secondary coils, and FIG. 9B shows an alternative (bottom) view of the first section 810 of FIG. 9A. FIG. 9C shows a second section 820 of either of the secondary coils, and FIG. 9D shows an alternative (bottom) view of the second section 820 of FIG. 9C.

The first section 810 of the secondary coils 802, 804 includes a first of turns 812 including a first diameter and a second set 814 of turns including a second diameter smaller than the first diameter, and the second section 820 of the secondary coils 802, 804 includes a first of turns 822 including a first diameter and a second set 824 of turns including a second diameter smaller than the first diameter.

A first section 810 as shown in FIGS. 9A and 9B, and a second section 820 as shown in FIGS. 9C and 9D combine to form each secondary coil 802, 804 (the secondary coil 802 and the additional secondary coil 804). FIG. 9E shows the secondary coil 802 and the additional secondary coil 804 formed from the first and second sections 810, 820 in isolation. Different shading patterns are used for each secondary coil in FIG. 9E. To form each secondary coil 802, 804, the first section 810 and second section 820 of each secondary coil 802, 804 are electrically connected in parallel and are wound around the common winding axis, with the second set of turns 824 of the second section 820 positioned within the first set of turns 812 of the first section 810, and the second set of turns 814 of the first section 810 positioned within the first set of turns 822 of the second section 820, when viewed along the common winding axis.

In other words, the first section 810 and a second section 820 of the secondary coils 802, 804 are analogous to the first and second sections 710, 720 described above. The other features described above for the primary coil 702 apply analogously to the secondary coil 802 and additional secondary coil 804 and will therefore not be repeated here.

As shown in FIG. 9E, the secondary coils 802, 804 neatly stack together, with both being arranged around the same common winding axis. The secondary coils 802, 804 are stacked such that the secondary coil 802 and the additional secondary coil 804 fully overlap when viewed along the common winding axis (i.e. include the same footprint). The stacking of the secondary coils 802, 804 in beneficial for reducing the overall size of the winding arrangement 800.

The connection terminals 816, 826 of the secondary coils are folded so as to extend in a direction parallel or substantially parallel within manufacturing and/or measurement tolerances to the direction of the common winding axis, in this case in the same direction as the connection terminals 716, 726 of the primary coil 702 when the secondary coils 802, 804 are combined with the primary coil 702 (as shown in FIGS. 8A and 8B). When the winding arrangement 800 is fully constructed, the connection terminals 816, 826 of the secondary coils 802, 804 are located on opposing sides of the winding arrangement to the connection terminals 716, 726 of the primary coil 702, similarly to the preferred embodiment shown in FIG. 7A. Moreover, the connection terminals 816, 826 of the secondary coil 802 are arranged adjacent to each other, and the connection terminals 816, 826 of the additional secondary coil 804 are also arranged adjacent to each other. This positioning of the connection terminals makes it easier to identify which connection terminals 816, 826 belong to which secondary coil.

To form the complete winding arrangement 800 shown in FIGS. 8A and 8B, the turns of the primary coil 702 (shown in FIG. 7E) are interleaved with the turns of the secondary coil 802 and additional secondary coil 804 (shown in FIG. 9E).

In the present preferred embodiment, the primary coil 702 is interleaved with the secondary coils 802, 804 such that each turn of the secondary coil 802 is disposed between two turns of the primary coil 702 and each turn of the additional secondary coil 804 is disposed between two turns of the primary coil 702, when viewed along a direction perpendicular to the common winding axis. Therefore, each turn of each secondary coil 802, 804 has turns of the primary coil 702 located above and below the secondary coil turn. Once interleaved, each of the primary coil 702, secondary coil 802, and additional secondary coil 804 fully overlap when viewed along the common winding axis.

In the present preferred embodiment, the secondary coils 802 and 804 are stacked one on top of the other. This means that the secondary coil 802 interleaves with the primary coil 702 in a first portion of the primary coil 702 (the upper portion of the primary coil 702 in FIGS. 8A and 8B), and the additional secondary coil 804 interleaves with the primary coil 702 in a second portion of the primary coil 702 (the lower portion of the primary coil 702 in FIGS. 8A and 8B). Therefore, the turns of the primary coil 702 and the turns of the secondary coil 802 alternate along a first portion of the common winding axis, and the turns of the primary coil 702 and the turns of the additional secondary coil 804 alternate along a second portion of the common winding axis.

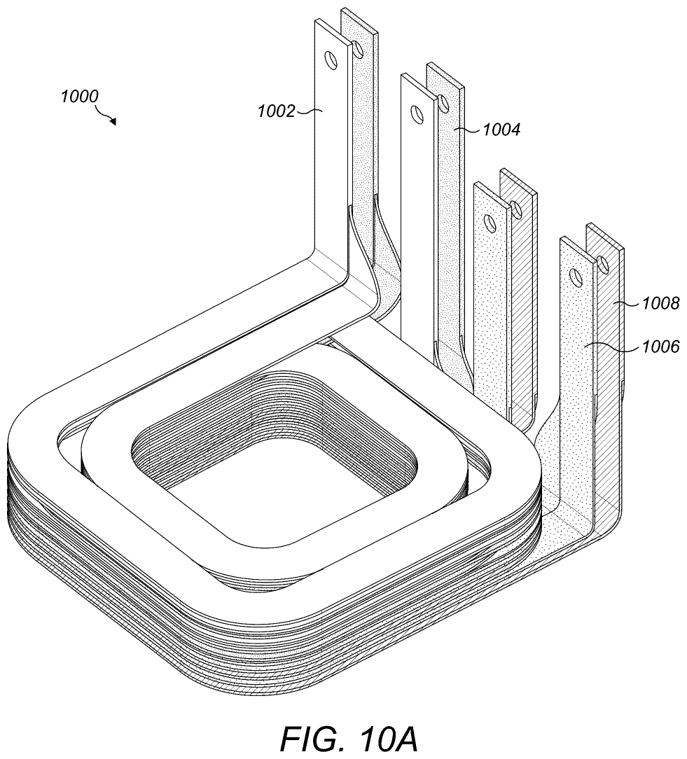

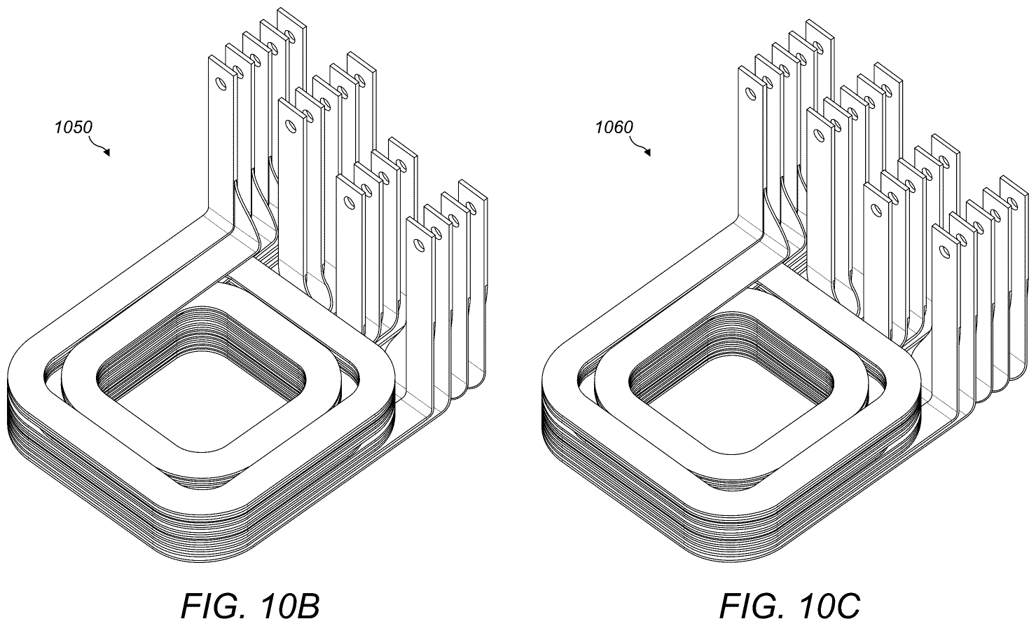

In an alternative preferred embodiment, the secondary coil 802 and additional secondary coil 804 could interleave with each other as well as the primary coil 702. This will be described in more detail in relation to FIG. 10A.

The interleaving of the primary coil 702 with the secondary coils 802, 804 again reduces the proximity effect by ensuring conductors carrying like currents are not positioned against each other.

Moreover, similarly to the primary coil, each secondary coil is formed by two coil sections in parallel. In other words, FIG. 9E shows two secondary coils 802, 804 formed from four coil sections. The use of the parallel coil sections in the primary and secondary coils 702, 802, 804 results in a winding arrangement 800 that is able to handle higher currents.

In further preferred embodiments, more than two secondary coils may be used. In other words, the winding arrangement may include more than one additional secondary coil. FIG. 10A shows a preferred embodiment including four secondary coils: secondary coil 1002, and additional secondary coils 1004, 1006, 1008. Different shading patterns are used for each secondary coil in FIG. 10A.

The secondary coils 1002, 1004, 1006, 1008 of FIG. 10A each include the same structure as the secondary coils 802, 804 described above, and a description will therefore not be repeated here. Again, due to the shape and configurations of the secondary coils 1002, 1004, 1006, 1008, the coils neatly stack together, resulting in a more compact winding arrangement.

However, the preferred embodiment of FIG. 10A differs in that the secondary windings 1002, 1004, 1006, 1008 are interleaved with each other. Specifically, the secondary coils 1002 and first additional secondary coil 1004 interleave with each other, and the second additional secondary coil 1006 and third additional secondary coil 1008 interleave with each other. In general, some or all of the secondary coils 1002, 1004, 1006, 1008 may be interleaved with each other. Each pair of secondary windings may be fully interleaved with each other, or only partially interleaved with each other, such that only some of the turns of each secondary coil interleave.

The secondary coil arrangement 1000 of FIG. 10A is then interleaved with the primary coil 702 of FIG. 7E, to form the full winding arrangement. The interleaving is such that each turn of each secondary coil 1002, 1004, 1006, 1008 is positioned between two turns of the primary coil 702, when viewed along a direction perpendicular to the common winding axis, to reduce the proximity effect.

Of course, other numbers of secondary coils may be used. In general, up to twenty secondary coils, or up to ten secondary coils may be used. FIG. 10B shows a secondary coil arrangement 1050 including nine secondary coils (one secondary coil and eight additional secondary coils). Similarly, FIG. 10C shows a secondary coil arrangement 1060 including ten secondary coils (one secondary coil and nine additional secondary coils). In other specific preferred embodiments, three, five, six, seven, or eight secondary coils may be used.

The shape of the primary and secondary coils in the above mentioned preferred embodiments provides flexibility to accommodate multiple secondary coils within the same footprint and volume. The coils of the winding arrangement stack around the common winding axis to provide a very compact arrangement, while also preventing proximity effect losses.

Including multiple secondary coils in the winding arrangement provides a number of benefits, including the ability to power multiple circuits, as well as providing redundancy.

In general, when multiple secondary coils are used, the number of turns in the primary coil 702 is greater than or equal to the combined total number of turns in the secondary coils (the secondary coil and the one or more additional secondary coils). For example, when using a primary coil 702 with ten turns in each coil section (for example, five turns in the first set of turns of each coil section, and five turns in the second set of turns in each coil section), a single secondary coil with up to ten turns in each coil section may be used, or two secondary coils with up to five turns in each coil section each may be used, or five secondary coils with two turns in each coil section each may be used. It is also possible, however, for the primary coil to include fewer turns than the combined total number of turns in the secondary coils in some preferred embodiments.

Each of the above-described preferred embodiments uses secondary coils with two sections connected in parallel, for higher current applications. FIGS. 11A to 12D show examples of secondary coil arrangements including a plurality of secondary coils suitable for low-current applications, which do not include two sections connected in parallel in the secondary coils.

FIG. 11A shows a secondary coil arrangement for use in a preferred embodiment of the invention that includes two secondary coils 1102, 1104. Different shading patterns are used for each secondary coil in FIG. 11A. Each of the secondary coils 1102, 1104 includes a first set of turns 1112, 1122 including a first diameter and a second set of turns 1114, 1124 including a second diameter concentric with the first set of turns 1112, 1122. The first and second diameters are the same as the first and second diameters for the primary coil 702 described above. Each secondary coil also includes a pair of connection terminals 1116, 1126 at either end of the coil.

Put another way, each secondary coil 1102, 1104 in FIG. 11A can be formed from one of the coil sections 810, 820 shown in FIGS. 9A to 9D, but without a connection in parallel to a second coil section. The description relating to the coil sections 810, 820 therefore applies analogously here.

In FIGS. 11A to 12D, only one turn is shown in each set of turns, however in general each set of turns of each secondary coil 1102, 1104 may include more than one turn.

The two secondary coils 1102, 1104 are both wound around a common winding axis. The secondary coils 1102 and 1104 are stacked such that the secondary coils fully overlap when viewed along the common winding axis.

The secondary coils 1102, 1104 of FIG. 11A (and FIGS. 11B to 12D discussed below) are combined with the primary coil 702 shown in FIG. 7E including two parallel primary coil sections 710, 720, to form a complete winding arrangement. Again, the primary coil 702 and secondary coils 1102, 1104 are both wound around the same common winding axis and are combined by interleaving, with the turns of the primary coil 702 interleaved with the turns of the plurality of secondary coils 1102, 1104. The primary coil 702 is interleaved with the secondary coils 1102, 1104 such that each turn of the secondary coils is disposed between two turns of the primary coil when viewed along a direction perpendicular to the common winding axis. The above-described interleaving prevents losses due to the proximity effect.

FIGS. 11B and 11C show two different possible arrangements for stacking the secondary coils 1102, 1104. In FIGS. 11B and 11C the secondary coils 1102, 1104 are crossed over each other at different locations, rather than being stacked one on top of the other as shown in FIG. 11A without any crossing. In FIG. 11C, the secondary coils 1102, 1104 are arranged with the second set of turns 1124 of the second secondary coil 1104 positioned within the first set of turns 1112 of the first secondary coil 1102, and the second set of turns 1114 of the first secondary coil 1102 are positioned within the first set of turns 1122 of the second secondary coil 1104, when viewed along the common winding axis. In other words, the secondary coils 1102, 1104 may also be partially or fully interleaved with each other, analogously to as described for FIG. 10A. FIG. 11C shows the secondary coils 1102, 1104 interleaved in the case where only one turn is included in each set of turns.

As before, more than two secondary coils may be used. Up to twenty secondary coils, or up to ten secondary coils may be used. FIG. 12A shows a secondary coil arrangement including four secondary coils 1202, 1204, 1206, 1208. Different shading patterns are used for each secondary coil 1202, 1204, 1206, 1208 in FIG. 12A. FIG. 12B shows a secondary coil arrangement 1250 including nine secondary coils. FIG. 12C shows a secondary coil arrangement 1260 including ten secondary coils. In other specific preferred embodiments, three, five, six, seven, or eight secondary coils may be used.

Regardless of the number of secondary coils, due to the construction of the secondary coils, they can be neatly stacked together to form a more compact winding arrangement. The stacking arrangement in one preferred embodiment of the present invention including ten secondary coils (the preferred embodiment of FIG. 12C) is shown in FIG. 12D. Half of the secondary coils are shaded in FIG. 12D, to help show the stacking arrangement. The secondary coils in FIG. 12D are stacked one on top of the other. The secondary coils are then interleaved with the primary coil 702 as described above, with each portion of each secondary coil being positioned between two turns of the primary coil 702, when viewed along a direction perpendicular to the common winding axis, to reduce the proximity effect.

As in the previous preferred embodiments, the number of turns in the primary coil may be greater than or equal to the combined total number of turns in the plurality of secondary coils.

In general, various numbers of turns and various numbers of secondary coils may be used. In a specific preferred embodiment, the secondary coil arrangement 1260 shown in FIGS. 12C and 12D, with ten secondary coils each including a single turn in each of the first and second sets of turns, may be combined with the primary coil 702 of FIG. 7E including ten turns in each coil section 710, 720.

The number or turns shown in the drawings and given as examples in the description above are for exemplary purposes only. In general, in each preferred embodiment various different numbers of turns may be used in each coil.

In some preferred embodiments, the high current secondary coils of FIGS. 8A to 10B including two coil sections connected in parallel could be used within the same winding arrangement as the low-current secondary coils of FIGS. 11A to 12D.

Any of the above-described winding arrangements may be used with the hybrid construction transformer described in relation to FIGS. 2A to 6.

Moreover, the above-described winding arrangements may be used in combination with the cooling plate arrangement described in UK patent application publication GB2597470A and international patent application publication WO 2022/018436 A1, which are hereby incorporated by reference in their entirety.

### Winding Materials

The winding arrangements of each of the preferred embodiments described above are formed from flat wire. However, in some preferred embodiments other types of wire may also be used, such as round wire windings or the like.

The wire used in the winding arrangements of each of the preferred embodiments may be formed from various electrically conductive materials, such as copper or the like. However, in a preferred embodiment of the present invention, the wire used in the winding arrangement is formed from aluminum, as outlined below.

Traditionally, copper litz wires and copper foils are used in high frequency transformers. Murata's pdqb type windings (UK patent application publication GB2574481A and international patent application publication WO 2019/234453 A1) made it possible to use flat copper conductors in high-power, high-frequency transformers. In the preferred embodiment of the present invention aluminum wires, including, for example, aluminum flat wires, are used. Aluminum has not previously been used as a conductor in the windings of high-frequency, high-power transformers.

The use of aluminum as the conductive material in the windings has a number of benefits, particularly in larger high frequency transformers, which are becoming more prevalent due to new applications such as use in electric vehicles. First, aluminum has a lower density than traditional conductors such as cooper, and therefore leads to weight savings. Moreover, aluminum is cheaper than traditional conductors such as copper, leading to a lower manufacturing cost.

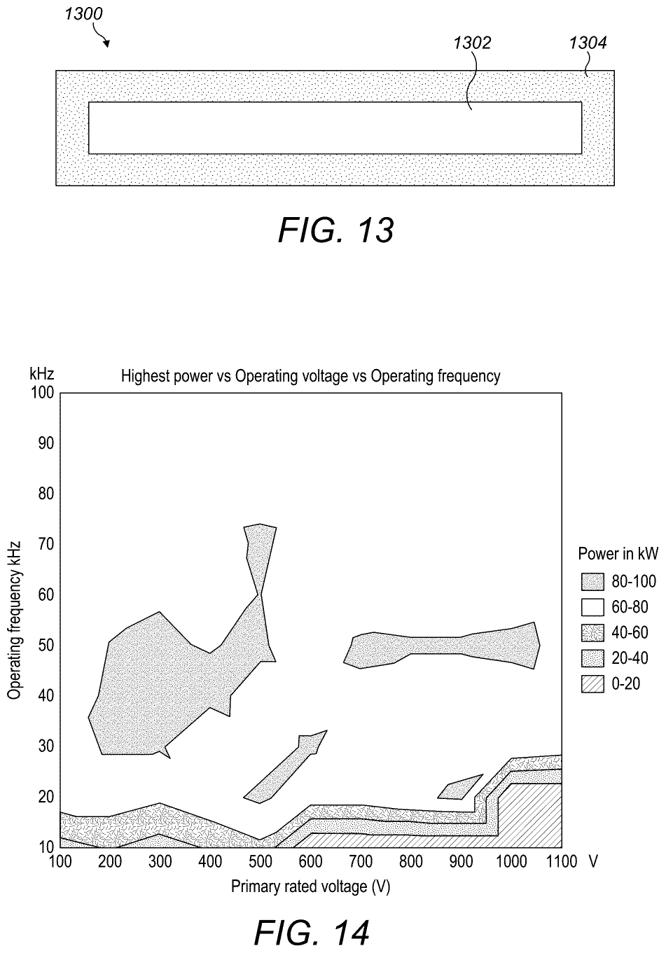

Second, carefully selected design parameters can be used with the aluminum windings to provide further benefits. The size of the thickness of the wire conductor is selected to be thicker than twice the skin depth of aluminum. This slight oversizing of the aluminum conductor means that there is an unused area within the center of the aluminum conductor (unused in the sense that it contains a very low or zero current density). FIG. 13 shows a cross section through an aluminum flat wire conductor 1300, with such a central area 1302 with a low or zero current density shown in FIG. 13. The majority of the current carried by the aluminum flat wire conductor 1300 is located within the outer area 1304.

Therefore, a central volume with a very low or zero current density runs along the entire length of the aluminum conductor. This central volume acts as a cooling channel running through the aluminum conductor itself, to allow heat generated within the aluminum conductor to travel along and eventually out of the aluminum conductor. In other words, the size of the aluminum conductor is chosen to make a positive use of the skin depth and proximity effect in the aluminum conductor.

In a particular preferred embodiment, the flat wire has a width of between about 10 mm and about 15 mm within manufacturing and/or measurement tolerances, and a thickness of between about 0.8 mm and about 1.2 mm within manufacturing and/or measurement tolerances. The thickness of the flat wire can be about 1 mm within manufacturing and/or measurement tolerances. The width and thickness directions are the directions perpendicular or substantially perpendicular within manufacturing and/or measurement tolerances to the direction of the extension of the wire, i.e. perpendicular or substantially perpendicular within manufacturing and/or measurement tolerances to the direction the current flows in. The width direction is the larger dimension of the wire perpendicular to the extension of the wire, and the thickness direction is the smaller dimension of the wire perpendicular to the extension of the wire.

In a first preferred embodiment, the flat wire has a width of 15±2 mm within manufacturing and/or measurement tolerances and a thickness of 1.0±0.2 mm within manufacturing and/or measurement tolerances. In a second preferred embodiment, the flat wire has a width of 10±2 mm within manufacturing and/or measurement tolerances, and a thickness of 1.0±0.2 mm within manufacturing and/or measurement tolerances.

The dimensions of the flat wire above may be used with any conductive material, such as copper. However, the dimensions above are specifically tailored to achieve the maximal beneficial effects, such as the cooling benefit, when aluminum is used as the conductive material.

In some preferred embodiments a mix of conductive materials may be used, for example different conductive materials may be used in each of the primary and secondary coils.

### Universal Transformer

FIG. 14 is a graph showing the maximum operating power as the operating voltage and the frequency are varied for an electrical transformer using both the hybrid construction and the winging arrangements described herein. In FIG. 14, the winding arrangement shown in FIG. 7A was used. As can be seen from FIG. 14, the electrical transformer can handle a power of between about 50 kW and about 100 kW across the majority of the voltage range of about 100 V to about 1100 V and the frequency range of about 10 kHz to about 100 kHz. As can be seen in the graph, in some regions, the electrical transformer can handle up to double the rated power of about 50 kW.

The hybrid transformer construction of FIGS. 2A to 6 and the winding arrangements of FIGS. 7A to 13 both contribute to providing a more adaptable transformer device capable of handling at least about 50 kW over the above-mentioned voltage and frequency ranges. Specifically, the hybrid construction of FIGS. 2A to 6 allows for both the winding unit and the cooling arrangement to be easily changed. The semi-open hybrid construction also improves the cooling when dealing with higher power levels. Moreover, the winding arrangement allows for multiple secondary coils to be used while retaining a compact structure and small footprint, allowing a transformer including the winding arrangement to power multiple circuits and/or provide redundancy in both high and low current situations.

Moreover, in each of the preferred embodiments described above, where multiple secondary coils are used, when the winding arrangement is used in a transformer two or more of the secondary coils may be connected together in series, or may be connected together in parallel, or may be connected together using a combination of series and parallel connections. For example, the two secondary coils 802, 804 shown in FIGS. 8A, 8B and 9E may be connected in series or parallel in some preferred embodiments, or in another preferred embodiment some or all of the secondary coils shown in each of FIGS. 10A to 12C may be connected together in series or parallel or a combination thereof. Many permutations of series and parallel connections are of course possible and may be selected based on the specific application of the transformer.

By modifying the series and parallel connections between the secondary coils (when multiple secondary coils are present in the winding arrangement), the transformer can be adjusted to be used over a larger voltage and frequency ranges. For example, in some preferred embodiments, a transformer using the winding arrangements with multiple secondary coils as described above can be used in the voltage range of about 100 V to about 1100 V, and the frequency range of about 5 kHz to about 120 kHz. In other words, modifying the series and parallel connections of the secondary coils allows the winding arrangement to be swapped between a high-current, low-voltage situation or a low-current, high-voltage situation, depending on the series and/or parallel connections made between the secondary coils. Therefore, only minor adjustments to these series and parallel connections can make the transformer universal over the desired power level, for example approximately 50 kW to approximately 100 kW.

Previous attempts to provide a universal transformer have included using different core sizes and/or core assemblies to make the transformer suitable for different voltage and frequency levels. This is not necessary with the above-described hybrid transformer construction and winding arrangements.

In general, the above-described concepts and preferred embodiments may be applied to all high-power, high-frequency transformers including those with higher or lower power ratings than about 50 kW. Moreover, the concepts described herein could also be used in high-power inductors or the like.

In use in a transformer, the connection terminals of the primary coil of the winding arrangements described above act as input terminals for an alternating current (AC) voltage source. This will result in an AC voltage being produced at the connection terminals of the one or more secondary coil(s). In other words, the connection terminals of the one or more secondary coil(s) act as output terminals. A load may be connected across the output terminals. In some preferred embodiments, by varying the number of turns in each coil, a step-up or step-down in voltage can be achieved.

A transformer according to preferred embodiments of the present invention may be used individually or as a bank of connected or unconnected transformers. Transformers according to preferred embodiments of the present invention may be used in various applications, such as use in a vehicle, for example in a regenerative braking system, or in power generation equipment, particularly in renewable energy systems, or in DC-DC converters, power inverters, radio-frequency electronic equipment, or in miniature scale transformers. It is noted that this list is not intended to be exhaustive, and that other applications are also contemplated.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A winding arrangement for an electrical transformer, the winding arrangement comprising a primary coil and a secondary coil, wherein:
the primary coil and the secondary coil each include a first section and a second section, and each of the first and second sections include a first set of turns having a first diameter and a second set of turns having a second diameter;
the first diameter is larger than the second diameter;
the first section and the second section of the primary coil are electrically connected in parallel and are wound around a common winding axis, with the second set of turns of the second section positioned within the first set of turns of the first section, and the second set of turns of the first section positioned within the first set of turns of the second section, when viewed along the common winding axis;
the first section and the second section of the secondary coil are electrically connected in parallel and are also wound around the common winding axis, with the second set of turns of the second section positioned within the first set of turns of the first section, and the second set of turns of the first section positioned within the first set of turns of the second section, when viewed along the common winding axis; and
turns of the primary coil are interleaved with turns of the secondary coil.

2. The winding arrangement of claim 1, wherein the primary coil is interleaved with the secondary coil such that each turn of the secondary coil is disposed between two turns of the primary coil when viewed along a direction perpendicular to the common winding axis.

3. The winding arrangement of claim 1, wherein the primary coil is interleaved with the secondary coil such that turns of the first set of turns of the primary coil and turns of the first set of turns of the secondary coil alternate along the common winding axis, and turns of the second sets of turns of the primary coil and turns of the second sets of turns of the secondary coil alternate along the common winding axis.

4. The winding arrangement of claim 1, wherein the primary coil is identical to the secondary coil.

5. The winding arrangement of claim 4, wherein the secondary coil is rotated by 180° about the common winding axis relative to the primary coil.

6. The winding arrangement of claim 1, further comprising one or more additional secondary coils, wherein:
the one or more additional secondary coils each include a first section and a second section, and each of the first and the second sections include a first set of turns having the first diameter and a second set of turns having the second diameter;
the first section and the second section of each additional secondary coil are electrically connected in parallel and are wound around the common winding axis, with the second set of turns of the second section positioned within the first set of turns of the first section, and the second set of turns of the first section positioned within the first set of turns of the second section, when viewed along the common winding axis; and
the turns of the primary coil are interleaved with turns of the one or more additional secondary coils.

7. The winding arrangement of claim 6, wherein the primary coil is interleaved with the secondary coil and the one or more additional secondary coils such that:
each turn of the secondary coil is disposed between two turns of the primary coil when viewed along a direction perpendicular to the common winding axis; and
each turn of the one or more additional secondary coils is disposed between two turns of the primary coil when viewed along a plane containing the common winding axis.

8. The winding arrangement of claim 6, wherein the primary coil is interleaved with the secondary coil and the one or more additional secondary coils such that:
turns of the first set of turns of the primary coil and turns of the first set of turns of the secondary coil alternate along a first portion of the common winding axis, and turns of the second sets of turns of the primary coil and turns of the second sets of turns of the secondary coil alternate along the first portion of the common winding axis; and
turns of the first set of turns of the primary coil and turns of the first set of turns of the one or more additional secondary coils alternate along a second portion of the common winding axis, and turns of the second sets of turns of the primary coil and turns of the second sets of turns of the one or more additional secondary coils alternate along the second portion of the common winding axis.

9. The winding arrangement of claim 6, wherein a number of turns in the primary coil is greater than or equal to a combined total number of turns in the secondary coil and the one or more additional secondary coils.

10. The winding arrangement of claim 6, wherein the winding arrangement includes up to nine additional secondary coils.

11. The winding arrangement of claim 6, wherein the secondary coil and the one or more additional secondary coils are stacked such that the secondary coil and the one or more additional secondary coils fully overlap when viewed along the common winding axis.

12. The winding arrangement of claim 1, wherein the primary coil and the secondary coil fully overlap when viewed along the common winding axis.

13. The winding arrangement of claim 1, wherein, for each of the primary and the secondary coils, a number of turns in the first set of turns of the first section and a number of turns in the first set of turns of the second section are equal, and a number of turns in the second set of turns of the first section and a number of turns in the second set of turns of the second section are equal.

14. The winding arrangement of claim 1, wherein for each of the first and the second sections of each of the primary and the secondary coils, a number of turns in the first set of turns is equal to a number of turns in the second set of turns.

15. The winding arrangement of claim 1, wherein the first set of turns and the second set of turns of each of the first and the second sections of each of the primary and the secondary coils are concentric about the common winding axis

16. The winding arrangement of claim 1, wherein each of the primary and the secondary coils include aluminum flat wire having a rectangular, square, or circular shape.

17. The winding arrangement of claim 17, wherein the aluminum flat wire has a width of between about 10 mm and about 15 mm, and a thickness of between about 0.8 mm and about 1.2 mm.

18. A winding arrangement for an electrical transformer, the winding arrangement comprising a primary coil and a plurality of secondary coils, wherein:
the primary coil includes a first section and a second section, and each of the first and second sections include a first set of turns having a first diameter and a second set of turns having a second diameter;
the first diameter is larger than the second diameter;
the first section and the second section of the primary coil are electrically connected in parallel and are wound around a common winding axis, with the second set of turns of the second section positioned within the first set of turns of the first section, and the second set of turns of the first section positioned within the first set of turns of the second section, when viewed along the common winding axis;
each of the plurality of secondary coils includes a first set of turns having the first diameter and a second set of turns having the second diameter, both wound around the common winding axis; and
turns of the primary coil are interleaved with turns of the plurality of secondary coils.

19. The winding arrangement of claim 18, wherein the primary coil is interleaved with the plurality of secondary coils such that each turn of the plurality of secondary coils is disposed between two turns of the primary coil when viewed along a direction perpendicular to the common winding axis.

20. An electrical transformer comprising:
a transformer core; and
the winding arrangement of claim 1 arranged around the transformer core.
